(19) United States
(12) Patent Application Publication
(10) Pub. No.: US 2024/0364029 A1
(43) Pub. Date: Oct. 31, 2024

(54) HIGH-SPEED HYBRID CARD EDGE CONNECTOR

(71) Applicant: Amphenol Commercial Products (Chengdu) Co., Ltd., Chengdu (CN)

(72) Inventors: Lu Song, Dongguan (CN); Liaoju Cen, Dongguan (CN); Nan Qiu, Chendgu (CN)

(73) Assignee: Amphenol Commercial Products (Chengdu) Co., Ltd., Chengdu (CN)

(21) Appl. No.: 18/767,779

(22) Filed: Jul. 9, 2024

Related U.S. Application Data
(63) Continuation of application No. PCT/CN2023/073085, filed on Jan. 19, 2023.

(30) Foreign Application Priority Data
Jan. 24, 2022 (CN) 202220183617.1
Jul. 6, 2022 (CN) 202221740479.9
Jul. 6, 2022 (CN) 202221855424.2
Aug. 31, 2022 (CN) 202211066380.X
Aug. 31, 2022 (CN) 202222321979.5

(51) Int. Cl. H01R 12/73; H01R 12/72

(52) U.S. Cl. CPC H01R 12/737; H01R 12/721

(57) ABSTRACT

A compact card edge connector for transmitting power and high-speed signals. The connector has a housing with a first portion holding first conductors and a second portion holding second conductors. Mounting ends of the first conductors extend out of the first portion and are configured to mount to a printed circuit board for power transmission. Mounting ends of the second conductors extend out of the second portion and are configured to mount with cables for signal transmission. The mounting ends of the second conductors are recessed from respective intermediate portions. The housing has a bottom member with projections abutting the mounting ends of first-type second conductors, and a lossy member electrically coupling second-type second conductors. Such a configuration meets signal integrity requirements in connectors designed for 32 Gbps and 64 Gbps and beyond, while conforming to a standard that constrains mating and mounting interfaces.

### CROSS-REFERENCE TO RELATED APPLICATIONS

This application is a continuation of International Application No. PCT/CN2023/073085, filed on Jan. 19, 2023, entitled “HIGH-SPEED HYBRID CARD EDGE CONNECTOR,” which claims priority to and the benefit of Chinese Patent Application No. 202222321979.5, filed on Aug. 31, 2022. International Application No. PCT/CN2023/073085 also claims priority to and the benefit of Chinese Patent Application No. 202211066380.X, filed on Aug. 31, 2022. International Application No. PCT/CN2023/073085 also claims priority to and the benefit of Chinese Patent Application No. 202221855424.4, filed on Jul. 6, 2022. International Application No. PCT/CN2023/073085 also claims priority to and the benefit of Chinese Patent Application No. 202221740479.9, filed on Jul. 6, 2022. International Application No. PCT/CN2023/073085 also claims priority to and the benefit of Chinese Patent Application No. 202220183617.1, filed on Jan. 24, 2022. The contents of these applications are incorporated herein by reference in their entirety.

### FIELD

This application relates generally to electrical interconnection systems, such as those including electrical connectors, used to interconnect electronic assemblies.

### BACKGROUND

Electrical connectors are used in many electronic systems. It is generally easier and more cost effective to manufacture a system as separate electronic subassemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

A known arrangement for joining several printed circuit boards is to have one printed circuit board serve as a backplane. A known backplane is a PCB onto which many connectors may be mounted. Conducting traces in the backplane may be electrically connected to signal conductors in the connectors so that signals may be routed between the connectors. Other printed circuit boards, called “daughterboards” or “daughtercards” may be connected through the backplane. For example, daughtercards may also have connectors mounted thereon. The connectors mounted on a daughtercard may be plugged into the connectors mounted on the backplane. In this way, signals may be routed among daughtercards through the connectors and the backplane. The daughtercards may plug into the backplane at a right angle. The connectors used for these applications may therefore include a right angle bend and are often called “right angle connectors.”

Connectors may also be used in other configurations for interconnecting printed circuit boards. Sometimes, one or more printed circuit boards may be connected to another printed circuit board, called a “motherboard,” that is both populated with electronic components and interconnects the daughterboards. In such a configuration, the printed circuit boards connected to the motherboard may be called daughterboards. The daughterboards are often smaller than the motherboard and may sometimes be aligned parallel to the motherboard. Connectors used for this configuration are often called “stacking connectors” or “mezzanine connectors.” In other systems, the daughterboards may be perpendicular to the motherboard.

For example, this configuration is often used in computers in which the motherboard might have a processor and a bus configured to pass data between the processor and peripherals, such as a graphics processor or memory. Connectors may be mounted to the motherboard and connected to the bus. The peripherals may be implemented on daughtercards with connectors that mate with the connectors on the bus such that separately manufactured peripherals may be readily integrated into a computer made with the motherboard.

To enhance the availability of peripherals, the bus and the connectors used to physically connect peripherals via the bus may be standardized. In this way, there may be a large number of peripherals available from a multitude of manufacturers. All of those products, so long as they are compliant with the standard, may be used in a computer that has a bus compliant with the standard. Examples of such standards include serial ATA (SATA), serial attached SCSI (SAS), peripheral component interconnect express (PCIe), or SFF-8639, which are commonly used in computers. The standards have gone through multiple revisions, adapting to the higher performance expected from computers over time.

### SUMMARY

Aspects of the present disclosure relate to hybrid electrical connectors that can transmit power and high-speed signals simultaneously.

Some embodiments relate to an electrical connector. The electrical connector may comprise a housing comprising a first portion having a first slot, and a second portion separated from the first portion by a rib and having a second slot; a plurality of first conductors in the first portion of the housing, each of the plurality of first conductors comprising a mating end comprising a mating contact portion curving into the first slot, and a mounting end extending out of the first portion of the housing and configured to mount to a printed circuit board; and a plurality of second conductors in the second portion of the housing, each of the plurality of second conductors comprising a mating end comprising a mating contact portion curving into the second slot, a mounting end extending out of the second portion of the housing, and an intermediate portion joining the mating end and the mounting end. The mounting end may be thinner than the intermediate portion and configured for a cable to be attached to the mounting end.

Optionally, for each of the plurality of second conductors, the intermediate portion may comprise a first surface and a second surface on opposite sides; the mounting end may comprise a third surface and a fourth surface on opposite sides; the third surface of the mounting end may extend from the first surface of the intermediate portion; and the fourth surface of the mounting end may be offset from the second surface of the intermediate portion.

Optionally, the mating contact portions of the plurality of first conductors may have a first width in a longitudinal direction perpendicular to the mating direction; the mating contact portions of the plurality of second conductors may have a second width in the longitudinal direction; and the first width may be greater than the second width.

Optionally, the intermediate portions of the plurality of first conductors may have a third width in the longitudinal direction; and the third width may equal to the first width.

Optionally, the intermediate portions of the plurality of second conductors may have a fourth width in the longitudinal direction; and the fourth width may be greater than the second width.

Optionally, the first portion of the housing may comprise a plurality of first channels each configured to hold one of the plurality of first conductors, and a plurality of first separators at least partially dividing the plurality of first channels; each of the plurality of first separators may comprise one or more slots; each of the plurality of first conductors may comprise a wider portion adjacent the mounting end; and the wider portions may extend into the slots of the plurality of first separators.

Optionally, the electrical connector may comprise a subassembly housing holding the plurality of second conductors in a row in the longitudinal direction perpendicular to the mating direction. The second portion of the housing may comprise a plurality of second channels each configured to hold one of the plurality of second conductors, and a plurality of second separators at least partially dividing the plurality of second channels; and the subassembly housing may be disposed between the plurality of second separators and a wall of the housing.

Optionally, the plurality of first conductors may comprise a plurality of first-type first conductors and a plurality of second-type first conductors; the intermediate portion of each of the plurality of second-type first conductors may comprise a portion bending toward the first slot; and the plurality first-type first conductors and the plurality of second-type first conductors may alternate in a longitudinal direction perpendicular to the mating direction.

Optionally, the mating ends of the plurality of first conductors may be aligned in a first line parallel to the longitudinal direction; the mounting ends of the plurality of first-type first conductors may be aligned in a second line parallel to the first line; and the mounting ends of the plurality of second-type first conductors may be aligned in a third line parallel to the first line and offset from the second line in a transverse direction perpendicular to the mating direction and the longitudinal direction.

Optionally, the mating end of each of the plurality of first conductors may comprise a tip portion disposed on a shelf of the first portion of the housing.

Optionally, the mating end of each of the plurality of first conductors may comprise a tip portion disposed on a shelf of the second portion of the housing; and the shelf of the second portion of the housing may be below the shelf of the first portion of the housing in the mating direction.

Optionally, the tip portion of each of the plurality of first conductors may be thinner than the respective mating contact portion.

Optionally, the plurality of second conductors may comprise a plurality of first-type second conductors and a plurality of second-type second conductors; the intermediate portion of each of the plurality of first-type second conductors may comprise a surface slanted toward an adjacent first-type second conductor; and the intermediate portion of each of the plurality of second-type second conductors may comprise a portion bending toward an adjacent first-type second conductor.

Optionally, the intermediate portion of each of the plurality of second-type second conductors may comprise a projection protruding toward the second slot.

Some embodiments relate to an electrical connector. The electrical connector may comprise a housing comprising a first portion having a first slot, a second portion separated from the first portion by a rib and having a second slot, and a bottom member attached to the second portion; a plurality of first conductors held by the first portion of the housing, each of the plurality of first conductors comprising a mating end comprising a mating contact portion curving into the first slot, and a mounting end extending out of the first portion of the housing and beyond the bottom member in a mating direction; and a plurality of second conductors held by the second portion of the housing, each of the plurality of second conductors comprising a mating end comprising a mating contact portion curving into the second slot, and a mounting end extending out of the second portion of the housing and within the bottom member in the mating direction. The plurality of first conductors may be configured to mount to a printed circuit board; and the plurality of second conductors may be configured to mount with cables.

Optionally, the bottom member may comprise a body, a plurality of pillars extending from the body toward the second portion of the housing, and a plurality of projections extending from the pillars and toward the mounting ends of the plurality of second conductors.

Optionally, a portion of the plurality of projections may comprise a plurality of recesses; each of the plurality of second conductors may comprise a transition region between an intermediate portion and the mounting end; the plurality of second conductors may comprise a plurality of first-type second conductors and a plurality of second-type second conductors; and the transition regions of the plurality of first-type second conductors may be disposed in respective recesses of the plurality of recesses.

Optionally, the housing may further comprise a lossy member configured to electrically couple the plurality of second-type second conductors.

Optionally, the lossy member may comprise a body, a plurality of first pillars extending from the body toward the second portion of the housing, and a plurality of second pillars extending from the body away from the second portion of the housing and disposed between adjacent pillars of the bottom member.

Optionally, the plurality of second pillars of the lossy member may comprise a plurality of recesses; and the transition regions of the plurality of second-type second conductors may be disposed in respective recesses of the plurality of recesses of the plurality of second pillars of the lossy member.

Optionally, the plurality of first pillars of the lossy member may comprise a plurality of projections protruding toward the plurality of second-type second conductors.

Optionally, for each of the plurality of second-type second conductors, the corresponding recess of the second pillar may be offset from the projection of the first pillar in a longitudinal direction perpendicular to the mating direction.

Optionally, the lossy member may comprise a plurality of first openings; the bottom member may comprise a plurality of second openings stacked below respective ones of the plurality of first openings of the lossy member in the mating direction; and the second portion of the housing may comprise a plurality of projections each extending through a first opening of the lossy member and a second opening of the bottom member.

Optionally, the electrical connector may further comprise a subassembly housing holding the plurality of second conductors in a row in the longitudinal direction perpendicular to the mating direction, the subassembly housing comprising a plurality of projections disposed in matching openings of the second portion of the housing.

Optionally, the intermediate portion of each of the plurality of second-type second conductors may comprise a projection protruding toward the second slot; and the subassembly housing may comprise a plurality of openings disposed corresponding to the projections of the plurality of second-type second conductors.

Some embodiments relate to an electronic system. The electronic system may include a printed circuit board; an electrical connector comprising: a housing comprising a first portion and a second portion, a plurality of first conductors in the first portion of the housing, each of the plurality of first conductors comprising a mounting end extending out of the first portion of the housing and mounted to the printed circuit board, and a plurality of second conductors in the second portion of the housing, each of the plurality of second conductors comprising a mounting end extending out of the second portion of the housing; and a plurality of cables, each of the plurality of cables comprising a pair of signal wires and at least one ground wire disposed adjacent to the pair of signal wires, each wire of the pair of signal wires and the at least one ground wire being welded to the mounting end of a respective one of the plurality of second conductors.

Optionally, the printed circuit board may comprise a recess or an opening such that the plurality of cables pass through the recess or opening.

Optionally, the housing of the electrical connector may be secured to the printed circuit board at locations on opposite sides of the recess or opening.

Optionally, the printed circuit board may be a first printed circuit board; the electronic system may comprise a second printed circuit board; and the second printed circuit board may be electrically coupled to the first printed circuit board through the plurality of first conductors of the electrical connector and electrically coupled to the plurality of cables through the plurality of second conductors of the electrical connector.

Some embodiments relate to an electrical connector. The electrical connector may comprise a housing comprising a first portion having a first slot, and a second portion separated from the first portion by a rib and having a second slot; a plurality of first conductors in the first portion of the housing, each of the plurality of first conductors comprising a mating end comprising a mating contact portion curving into the first slot, and a mounting end comprising a flat surface configured to mate with a third conductor; and a plurality of second conductors in the second portion of the housing, each of the plurality of second conductors comprising a mating end comprising a mating contact portion curving into the second slot, and a mounting end extending out of the second portion of the housing and configured to mount with cables.

Optionally, the mounting ends of the plurality of first conductors may be within the first portion of the housing.

Optionally, the mounting ends of the plurality of first conductors may be aligned in a line along a longitudinal direction.

Optionally, the electrical connector may comprise a power adaptor comprising: an adaptor housing; and a plurality of the third conductors held by the adaptor housing.

Optionally, each of the plurality of third conductors may comprise a mating end comprising a mating contact portion configured to mate with the flat surface of a respective first conductor, a mounting end configured to mount to a printed circuit board, and an intermediate portion between the mating end and the mounting end and fixed in the adaptor housing.

Optionally, the plurality of first conductors may be disposed in two rows; and the power adaptor may be disposed between the two rows of first conductors.

Optionally, each of the plurality of third conductors may comprise a mating contact portion curving toward the flat surface of a respective first conductor.

Optionally, each of the plurality of third conductors may comprise a mounting contact portion configured to surface mount to the printed circuit board.

These techniques may be used alone or in any suitable combination. The foregoing summary is provided by way of illustration and is not intended to be limiting.

### BRIEF DESCRIPTION OF THE DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1A is a top, front perspective view of a portion of an electronic system, illustrating a hybrid card edge connector having power conductors mounted on a printed circuit board, according to some embodiments.

FIG. 1B is a bottom, front perspective view of the electronic system of FIG. 1A.

FIG. 2A is a top, rear perspective view of the hybrid card edge connector of the electronic system of FIG. 1A, according to some embodiments.

FIG. 2B is a bottom, front perspective view of the hybrid card edge connector of FIG. 2A.

FIG. 2C is a partially exploded perspective view of the hybrid card edge connector of FIG. 2B, with the power conductors, signal conductors, and board lock hidden, showing an example in which an optional lossy member is installed in a bottom member.

FIG. 2CA is an enlarged view of a first portion of the hybrid card edge connector of FIG. 2B, with a few power conductors hidden.

FIG. 2D is a perspective view of the hybrid card edge connector of FIG. 2A, with a housing hidden.

FIG. 2E is a side view of power conductors of the hybrid card edge connector of FIG. 2A.

FIG. 2F is a perspective view of groups of signal conductors of the hybrid card edge connector of FIG. 2A.

FIG. 2G is a perspective view of the hybrid card edge connector of FIG. 2A, with the housing, board lock, power conductors, and some signal conductors hidden.

FIG. 2H is a partially exploded perspective view of the hybrid card edge connector of FIG. 2G, showing the lossy member and bottom member.

FIG. 3A is a front perspective view of a conductor subassembly of the hybrid card edge connector of FIG. 2A, according to some embodiments.

FIG. 3B is a back perspective view of the conductor subassembly of FIG. 3A.

FIG. 4A is a cross-sectional view of the hybrid card edge connector of FIG. 2A along a line marked “4A-4A” in FIG. 2A, showing power conductors.

FIG. 4B is a cross-sectional view of the hybrid card edge connector of FIG. 2A along a line marked “4B-4B” in FIG. 2A, showing signal conductors.

FIG. 4C is a cross-sectional view of the hybrid card edge connector of FIG. 2A along a line parallel to the line marked “4B-4B” in FIG. 2A, showing a first-type signal conductor and an upper portion of a second-type signal conductor.

FIG. 4D is a cross-sectional view of the hybrid card edge connector of FIG. 2A along another line parallel to the line marked “4B-4B” in FIG. 2A, showing a lower portion of the second-type signal conductor of FIG. 4C.

FIG. 4E is a cross-sectional view of the hybrid card edge connector of FIG. 2A along a separator of channels of the housing illustrated as a line marked “4E-4E” in FIG. 2C.

FIG. 5 is a bottom, side perspective view of a portion of an electronic system, illustrating a hybrid card edge connector having signal conductors mounted with cables, according to some embodiments.

FIG. 6 is a bottom, side view of a housing of the hybrid card edge connector of the electronic system of FIG. 5.

FIG. 7 is an enlarged perspective view of a portion inside the hybrid card edge connector of the electronic system of FIG. 5.

FIG. 8 is an enlarged perspective view of a portion of a lossy member of the hybrid card edge connector of the electronic system of FIG. 5.

FIG. 9 is a perspective view of the signal conductors of the hybrid card edge connector of the electronic system of FIG. 5.

FIG. 10 is a perspective view of a power conductor of the hybrid card edge connector of the electronic system of FIG. 5.

FIG. 11 is a top, front perspective view of a portion of an electronic system, illustrating a hybrid card edge connector having power conductors mounted on a printed circuit board, according to some embodiments.

FIG. 12 is a bottom, front perspective view of the portion of the electronic system of FIG. 11.

FIG. 13 is a top, front perspective view of a housing of the hybrid card edge connector of FIG. 11.

FIG. 14 is a bottom, rear perspective view of the housing of FIG. 13.

FIG. 15 is a top, front perspective view of the portion of the electronic system of FIG. 11, with the housing of FIG. 13 hidden.

FIG. 16 is a perspective view of a power conductor of the hybrid card edge connector of FIG. 11.

FIG. 17 is an enlarged view of a portion of a body of a signal conductor subassembly of the hybrid card edge connector of FIG. 11.

FIG. 18 is a perspective view of a second-type signal conductor of the hybrid card edge connector of FIG. 11.

FIG. 19 is a perspective view of a first-type signal conductor of the hybrid card edge connector of FIG. 11.

FIG. 20 is a perspective view of a bottom member and a lossy member of the hybrid card edge connector of FIG. 11.

FIG. 21 is a top, rear perspective view of a portion of an electronic system, illustrating a hybrid card edge connector having power conductors electrically coupled to a printed circuit board, according to some embodiments.

FIG. 22 is a perspective view of the electronic system of FIG. 21, with a housing of the hybrid card edge connector hidden.

FIG. 23 is an enlarged perspective view of a portion of the electronic system of FIG. 22.

FIG. 24 is a perspective view of a first-type signal conductor of the hybrid card edge connector of the electronic system of FIG. 21.

FIG. 25 is a perspective view of a second-type signal conductor of the hybrid card edge connector of the electronic system of FIG. 21.

FIG. 26 is an enlarged perspective view of a portion of the electronic system of FIG. 22, showing power conductors of the hybrid card edge connector mated with a power adapter.

FIG. 27 is a perspective view of a power conductor of the hybrid card edge connector of the electronic system of FIG. 21.

FIG. 28 is an enlarged perspective view of the power adapter of FIG. 26.

FIG. 29 is a perspective view of a conductor of the power adapter of FIG. 28.

FIG. 30 is an enlarged view of a portion of the hybrid card edge connector of the electronic system of FIG. 21, showing a bottom member and a lossy member.

FIG. 31 is a bottom perspective view of a housing of the hybrid card edge connector of the electronic system of FIG. 21.

### DETAILED DESCRIPTION

The Inventors have recognized and appreciated connector designs that support the use of high-speed add in cards in compact electronic systems. Such connectors may overcome challenges in system designs associated with incompatible requirements for power transmission and signal transmission, and maintain and/or improve signal integrity of the signals passing through a hybrid connector at higher speeds while ensuring that the add in card can receive adequate power without a significant increase in the size of the electronic system. Such connectors may be capable of passing power and high-speed signal simultaneously.

Such a connector may have a first portion with conductors configured to carry power and a second portion with conductors configured for high-speed signals. The conductors in the first portion may have mounting ends configured for connection to a printed circuit board to which the connector is mounted. The second portion of the connector may be configured to align with an opening through the PCB and high-speed conductors of the second portion may have mounting ends configured for termination of cables that pass through the opening in the PCB. The first portion and the second portion may be integrated to collectively provide a mating interface compliant with PCIe or another standard. A connector satisfying the mechanical requirements of the PCIe specification at the performance required for 32 Gbps and 64 Gbps and beyond is used as an example of a connector in which these techniques have been applied. The connector may be also compatible with speed rate lower than 32 Gbps such as PCIe Gen1 to Gen4.

Such an electrical connector may have one or more rows of conductors. Some conductors in a row may serve as power conductors, and some conductors may serve as high-speed signal conductors. Optionally, some conductors may serve as low-speed signal conductors. Some of the low-speed signal conductors and/or power conductors may also be designated as grounds, referencing the signals carried on the signal conductors or providing a return path for those signals. It should be appreciated that ground conductors need not to be connected to earth ground, but may carry reference potentials, which may include earth ground, DC voltages or other suitable reference potentials.

The connector may have a housing with a first portion configured for holding power conductors and a second portion configured for holding subassemblies of signal conductors some of which may carry high-speed signals. The first portion and the second portion may be separated from each other by, for example, a rib. A mounting face of the first portion may be disposed beyond a mounting face of the second portion in a mating direction. The housing may include a bottom member disposed at the mounting face of the second portion. The housing may further include a lossy member having a body disposed between the mounting face of the second portion and a body of the bottom member. Such a configuration may enable the power conductors in the first portion to be mounted to a printed circuit board (PCB) and the conductors in the second portion to transmit high-speed signals with high integrity through cables terminated to those conductors.

The first portion and the second portion may include channels configured for holding power conductors and signal conductors, respectively. The first portion may include a bar disposed adjacent a mating face of the connector and configured to serve as a shelf for holding tip portions of the power conductors. The second portion may include a bar disposed adjacent the mating face of the connector and projections extending from the bar and elongated in the mating direction. The projections may be configured to serve as a shelf for holding tip portions of the signal conductors. Such a configuration may enable the power conductors to mate to/demate from an electronic card engaging/disengaging the connector before the signal conductors. Such a configuration may also enable the signal conductors to have shorter tip portions and therefore improved signal integrity.

Each power conductor may include a mating end having a mating contact portion, a mounting end opposite the mating end, and an intermediate portion joining the mating end and the mounting end. The mating end may have a same width in the longitudinal direction as the intermediate portion, which may provide larger contact area for power transmission to an add in card. The mating ends for the power conductors in a row may be aligned in a line. In some embodiments, the mounting end may be configured to mount to a PCB. The intermediate portion of every other power conductor may include a portion bending toward an adjacent row such that the mounting ends of the power conductors in a row may be aligned in two different lines parallel to each other. Such a configuration may enable more power conductors in the connector while requiring no larger mounting area on a PCB than the specification by a standard. In some embodiments, the mounting end may be configured to mate with a power adaptor, which may be configured to mount to a PCB. Such a configuration may enable the power conductors to be electrically coupled to the PCB through the power adapter, which may eliminate the need to solder the power conductors on the PCB and therefore facilitate the following maintenance and reduce maintenance costs.

Each signal conductor may include a mating end having a mating contact portion, a mounting end configured to mount with cables, and an intermediate portion joining the mating end and the mounting end. The mating end may be narrower in the longitudinal direction than the intermediate portion, which may enable larger separations between the mating ends and therefore reduce cross talk at the mating interface. The intermediate portion may include a transition portion such that the mounting end is recessed from the intermediate portion, which may provide space for projections of the bottom member or lossy member to protrude in and therefore provide mechanical support to the mounting end. The resulting thinner mounting end may reduce the impedance impact of the added masses at the cable attachments and therefore reduce impedance imbalance at the mounting interface. The mounting ends of first-type signal conductors may abut the projections of the bottom member and therefore may be electrically isolated from each other. The mounting ends of second-type signal conductors may abut projections of the lossy member and therefore may be electrically coupled by the lossy member.

The first-type signal conductors and second-type signal conductors may be arranged in groups. Each group may be configured to be mounted with the wires of one cable. A group may include a pair of first-type signal conductors each configured to transmit a differential signal and a pair of second-type signal conductors configured to provide reference or return paths for the pair of first-type signal conductors carrying the differential signals. The pair of second-type signal conductors maybe disposed on opposite sides of the pair of first-type signal conductors. The intermediate portions of the pair of first-type signal conductors may include surfaces slanted toward each other to improve the coupling between the pair. The intermediate portions of the pair of second-type signal conductors may each include a portion bending toward the pair of first-type signal conductors such that the mounting ends of the pair of second-type signal conductors may be disposed closer to the mounting ends of the pair of first-type signal conductors. Such a configuration may enable the mating ends of the signal conductors having a first pitch configured for mating with an electronic card and the mounting ends of the signal conductors having a second pitch configured for mounting with cables. Such a configuration may compensate for the impedance impact of the added masses at the cable attachments and therefore reduce impedance imbalance.

The techniques described herein may be used alone or in any suitable combination. The following embodiments show examples of combinations of these techniques.

### First Embodiment

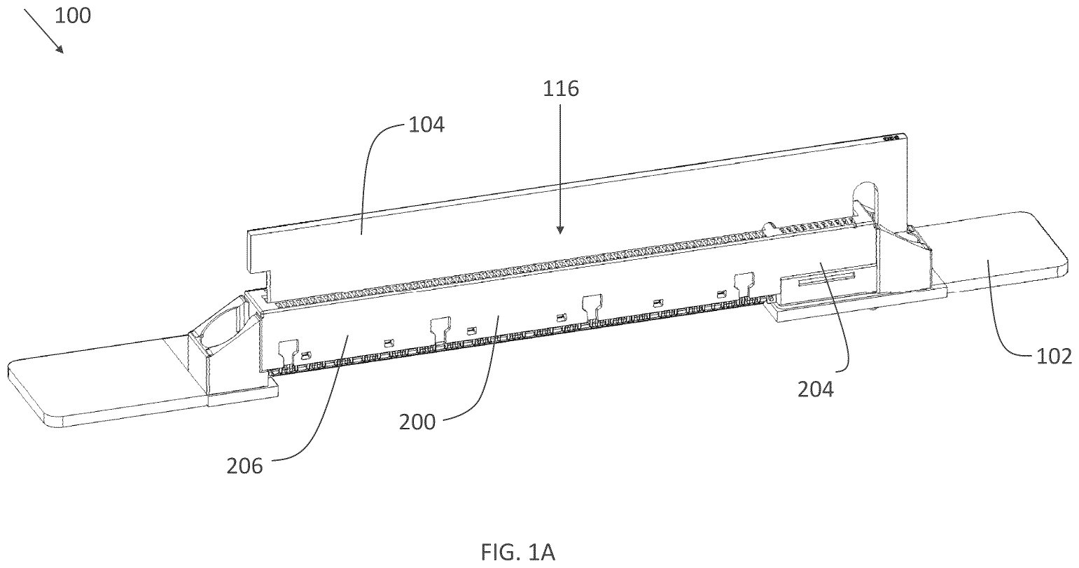

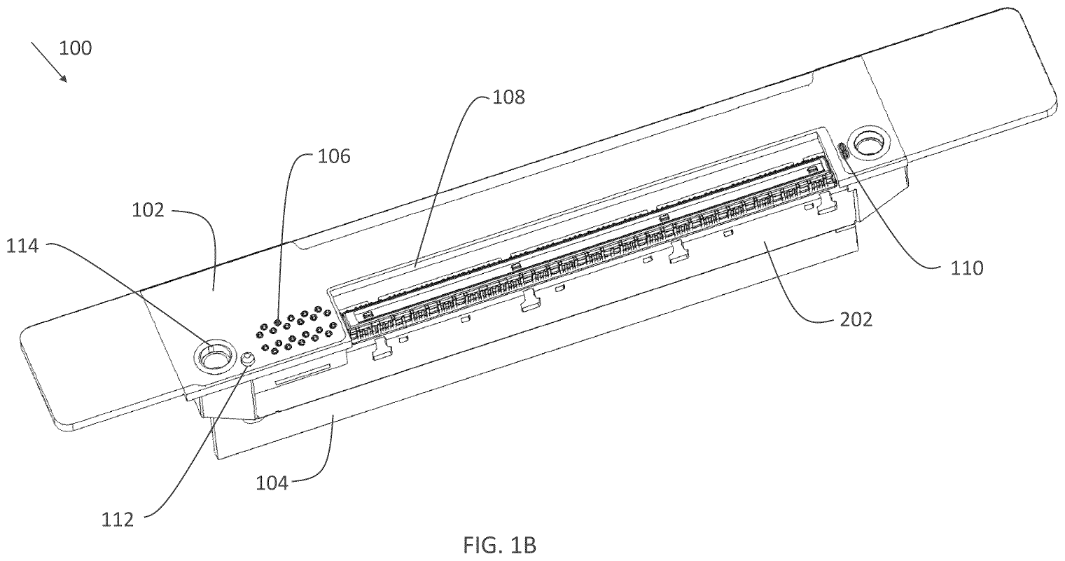

FIGS. 1A-4D are an example of techniques as described herein integrated into a hybrid card edge connector 200, which may be disposed in an electronic system 100. As illustrated in FIGS. 1A-1B, the electronic system 100 may include PCB 102, which the connector 200 may be mounted onto, and PCB 104, which may have an edge inserted into one or more slots of the connector 200 in a mating direction 116. In this example, PCB 102 is shown partially cut away, such that only portions of PCB 102 adjacent connector 200 are visible. The cutaway portions of PCB 102 may include other components of the system, such as semiconductor components, power regulators. Additionally, for simplicity of illustration, conductive structures within PCB 102 are not expressly illustrated. However, such a PCB may include power planes and/or ground planes, which may be coupled to power conductors within connector 200.

PCB 102 may include contact locations 106 configured for power conductors of the connector 200 to be mounted onto, and a recess 108 or an opening (not shown) for cables mounted onto signal conductors of the connector 200 to pass through such that the cables may be routed to designed locations on PCB 102 and/or another component in the system 100. Since the area of the contact locations 106 may be smaller than the area of the recess 108, PCB 102 may include features for securing a housing 202 of the connector 200 to PCB 102 when the connector 200 is mounted to PCB 102. In the illustrated example, PCB 102 includes a board lock receiver 110 on one side of the recess 108 and configured for receiving a board lock 226 of the connector 200, a guidepost receiver 112 on an opposite side of the recess 108 and configured for receiving a guidepost 224 of the connector 200, a pair of openings 114 on the opposite sides of the recess 108 configured for, for example, screws to pass through.

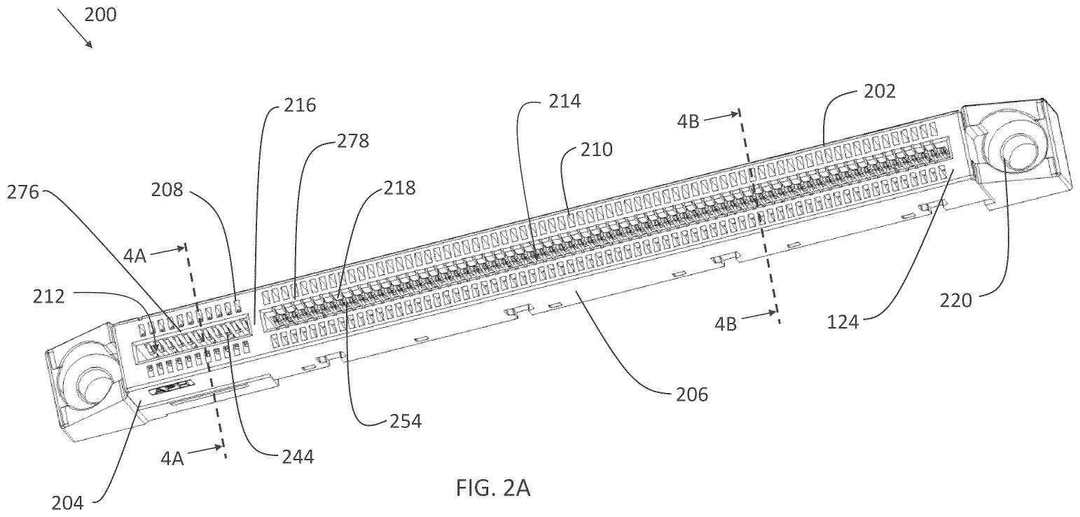

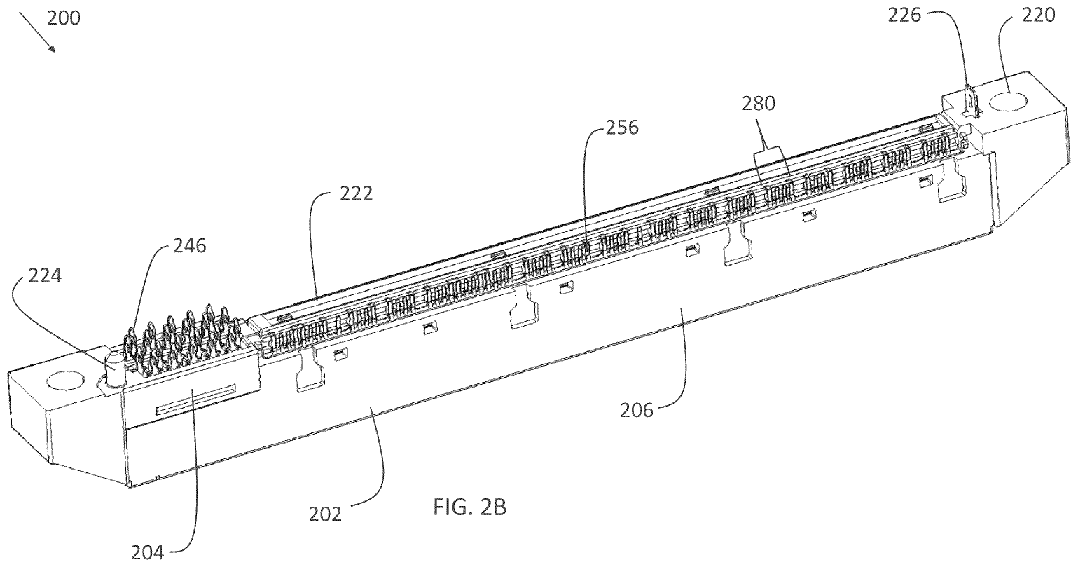

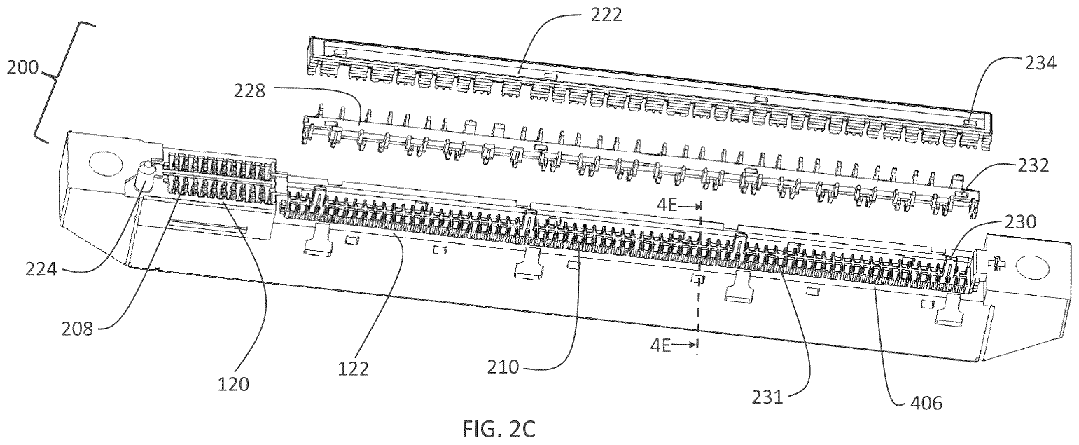

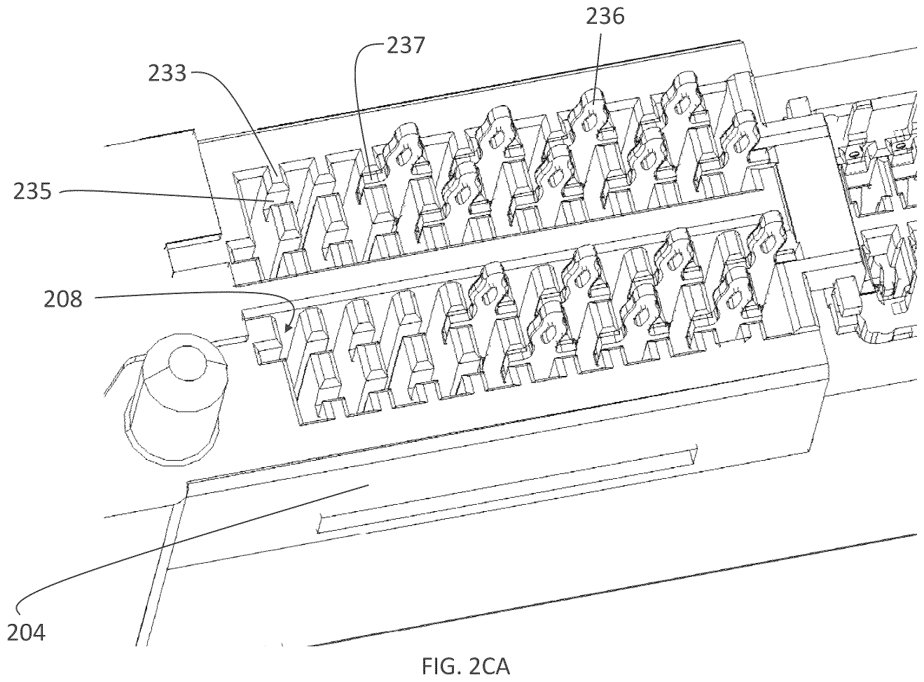

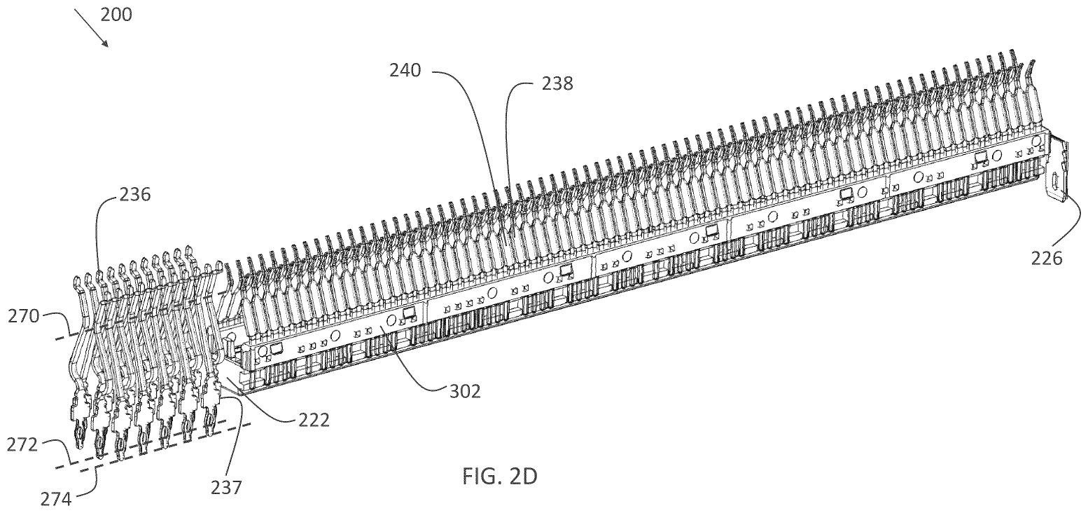

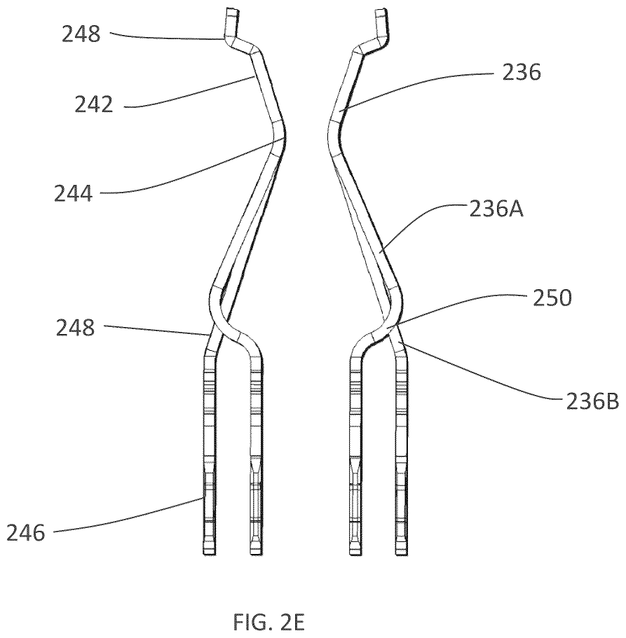

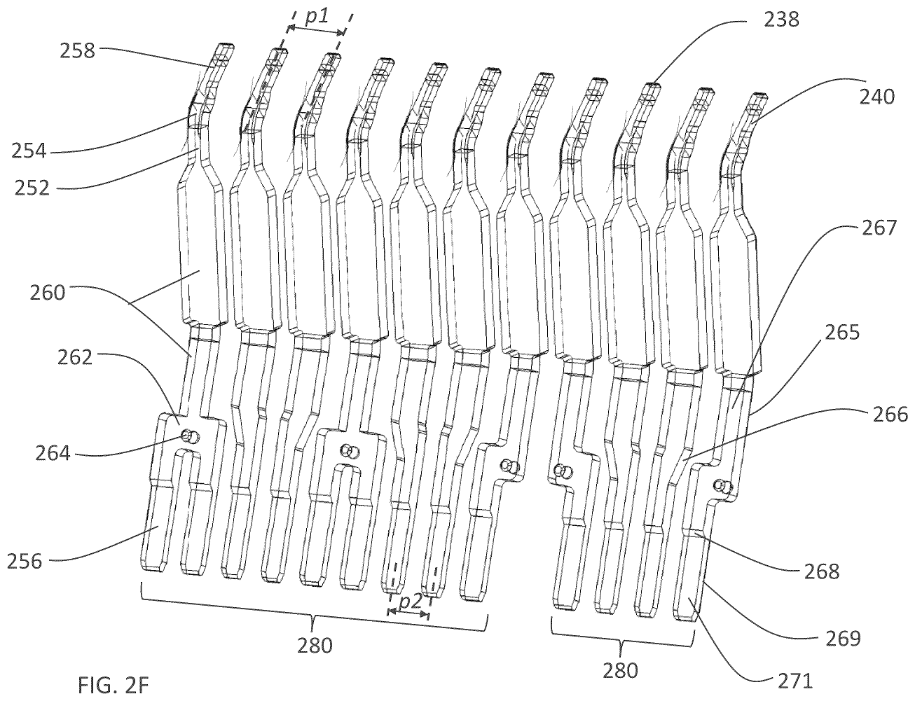

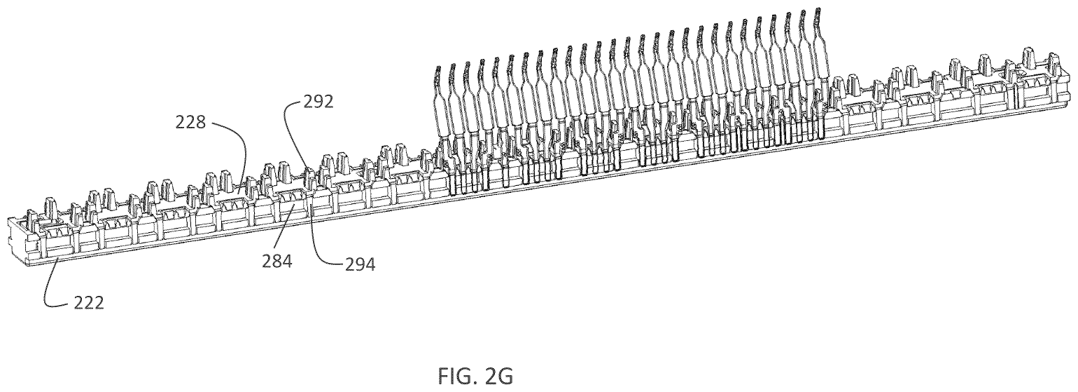

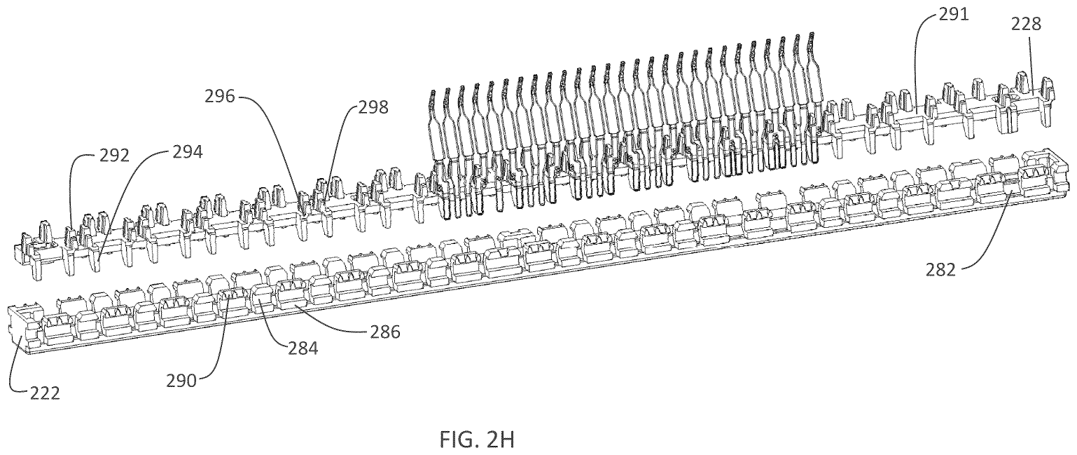

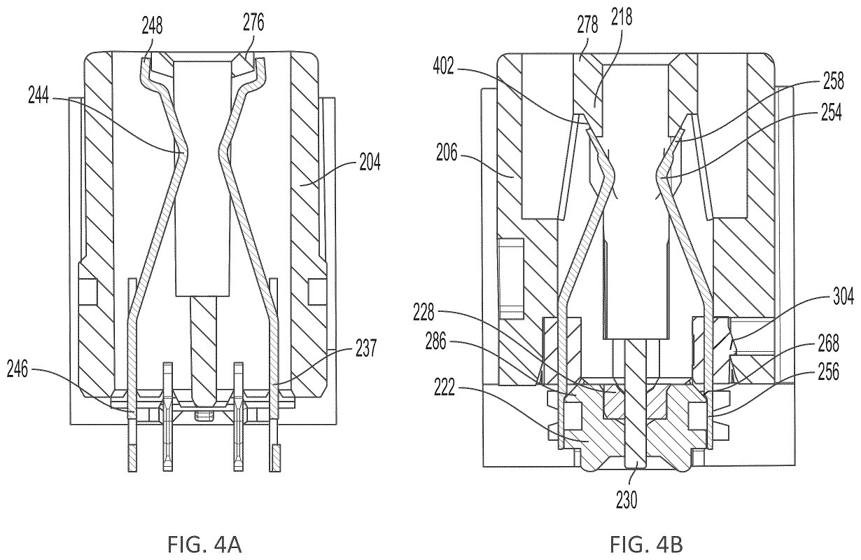

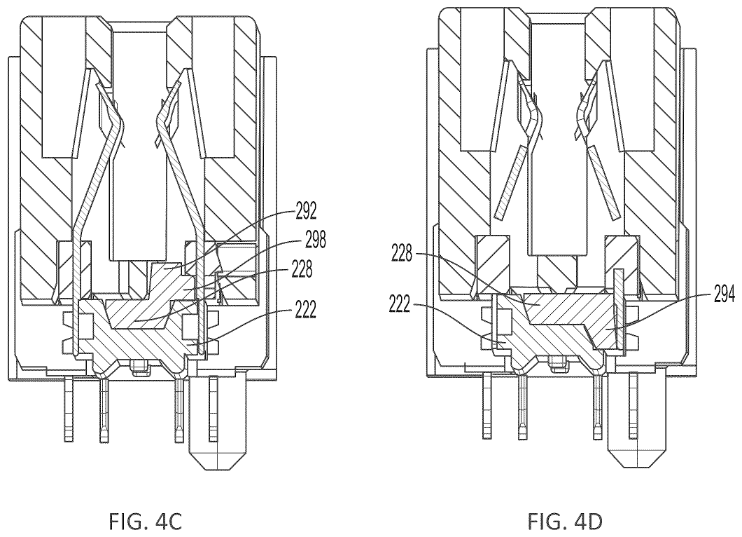

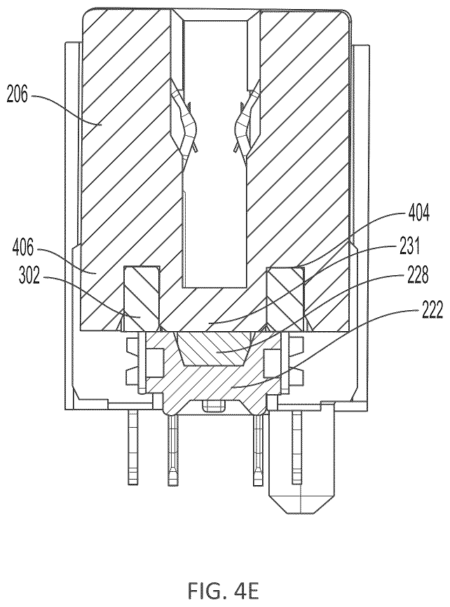

As illustrated in FIGS. 2A-2D, the connector 200 may include the housing 202, which may have a mating face 124 that PCB 104 may be inserted through. The housing 202 may include a first portion 204 and a second portion 206 separated from the first portion 204 by a rib 216. The first portion 204 may include a first slot 212 elongated in a longitudinal direction perpendicular to the mating direction 116, and first channels 208 at least partially divided by separators 233. Each first channel 208 may be configured for holding a power conductor 236 such that mating contact portions 244 of the power conductors 236 may curve into the first slot 212 for making contact with PCB 104 when it is inserted therein. Each separator 233 may include one or more slots 235 configured for wider portions 237 of the power conductors 236 to extend therein, which may ensure the power conductors 236 secured in respective channels 208. The first portion 204 may include a bar 276 adjacent the mating face 124 and configured to serve as a shelf for holding tip portions 248 of the power conductors 236 (see FIG. 4A).

The second portion 206 may include a second slot 214 elongated in the longitudinal direction, and second channels 210 at least partially divided by separators 231. Each second channel 210 may be configured for holding a signal conductor 238 or 240 such that mating contact portion 254 of the signal conductors 238 or 240 may curve into the second slot 214 for making contact with PCB 104 when it is inserted therein. The second portion 206 may include a bar 278 adjacent the mating face 124 and projections 218 extending from the bar 278 in the mating direction 116 such that the projections 218 may serve as a shelf for holding tip portions 258 of the signal conductors 238, 240 (see FIG. 4B). Such a configuration may enable the mating contact portions 254 of the signal conductors 238, 240 to be disposed lower in the mating direction 116 than the mating contact portions 244 of the power conductors 236, which may enable turning on and off the power before connecting the signals. The projections 218 may have surfaces 402 slanted toward the second slot 214 such that the signal conductors 238, 240 can have shorter tip portions 258, which may improve signal integrity.

The first portion 204 may have a mounting face 120 opposite the mating face 124. The first channels 208 may extend through the mating face 124 and the mounting face 120. The second portion 206 may have a mounting face 122 opposite the mating face 124 and disposed above the mounting face 120 of the first portion 204 in the mating direction 116. The second channels 210 may extend through the mating face 124 and the mounting face 122.

As illustrated in FIGS. 2D and 2E, the power conductors 236 held in the first portion 204 of the housing 202 may each include a mating end 242 comprising the mating contact portion 244 and tip portion 248, a mounting end 246 extending beyond the mounting face 120 of the first portion 204, and an intermediate portion 248. The mating end 242 may have a same width in the longitudinal direction as the intermediate portion 248, which may provide larger contact area for carrying sufficient power to an add in card (e.g., PCB 104). Each of the power conductors 236 may include a wider portion 237 adjacent the mounting end 246.

The power conductors 236 may include first-type power conductors 236A and second-type power conductors 236B disposed alternatively. The intermediate portion 248 of each of the first-type power conductors 236A may have a portion 250 bending inwardly. Such a configuration may enable more power conductors to be held by the first portion 204 without requiring a larger footprint.

Although the power conductors 236 are illustrated as separated conductors, it should be appreciated that the power conductors in a row may be stamped from a same sheet of metal and joined at their intermediate portions. Accordingly, there may be one power conductor on each side of the first slot 212 instead of a few separated ones.

Referring back to FIG. 2C, the housing 202 may include a bottom member 222 and a lossy member 228, both of which may be attached to the second portion 206. The second portion 206 may have projections 230 extending from the mounting face 122. The bottom member 222 may have openings 234, and the lossy member 228 may have openings 232 stacked with respective openings 234 of the bottom member 222 such that each projection 230 of the second portion 206 can extend through an opening 232 of the lossy member 228 and an opening 234 of the bottom member 222.

As illustrated in FIGS. 2H-2G, the bottom member 222 may include a body 282, pillars 284 extending from the body 282 toward the second portion 206, and projections 286 extending from the pillars 284 outwardly. Some of the projections 286 may have recesses 290, which may be configured for receiving transitions regions 268 of first-type signal conductors 238.

The lossy member 228 may include a body 291, upper pillars 292 extending front the body 291 toward the second portion 206, lower pillars 294 extending from the body 291 away from the second portion 206 and configured to be disposed between pillars 284 of the bottom member 222. The upper pillars 292 may include projections 298 protruding outwardly. The lower pillars 294 may include recesses 296, which may be configured for receiving transition regions 268 of second-type signal conductors 240. As illustrated, each upper pillar 292 may have a corresponding lower pillar 294, which may be offset from the upper pillar 292 in the longitudinal direction according to the configuration of a respective second-type signal conductor 240.

As illustrated in FIG. 2F, the signal conductors 238, 240 held in the second portion 206 of the housing 202 may each include a mating end 252 comprising the mating contact portion 254 and tip portion 258, a mounting end 256 extending beyond the mounting face 122 of the second portion 206, and an intermediate portion 260. The mating end 252 may have a width in the longitudinal direction less than that of the intermediate portion 260, which may increase separations between adjacent mating ends 252 and therefore reduce cross talk at the mating interface. Further, as shown in FIG. 2D, the mating end 252 of a signal conductor 238 or 240 may have a width in the longitudinal direction less than that of the mating end 242 of a power conductor 236. Such a configuration may enable the connector 200 for carrying sufficient power by the power conductors 236 and transmitting high-speed signals with high integrity by the signal conductors 238, 240.

The intermediate portion 260 of each of the signal conductors 238, 240 may include a transition region 268 such that the mounting end 256 may be recessed from the intermediate portion 260. For each of the signal conductors 238, 240, the intermediate portion 260 may comprises a first surface 265 and a second surface 267 on opposite sides. The mounting end 256 may comprise a third surface 269 and a fourth surface 271 on opposite sides. The third surface 269 of the mounting end 256 may extend from the first surface 265 of the intermediate portion 260. The fourth surface 271 of the mounting end 256 may be offset from the second surface 267 of the intermediate portion 260. Such a configuration may provide space for the projections 286 of the bottom member 222 or the lower pillars 294 of the lossy member 228 to protrude in and therefore provide mechanical support to the mounting end 256. The resulting thinner mounting end 256 may reduce the impedance impact of the added mass of a cable wire attached to the mounting end 256 and therefore reduce impedance imbalance at the mounting interface.

The signal conductors 238, 240 may include first-type signal conductors 238 and second-type signal conductors 240. The first-type signal conductors 238 may be configured for transmitting high-speed signals or low-speed signals. The second-type signal conductors 240 may be configured for providing reference or return path for the signals. As illustrated in FIGS. 4B-4D, the mounting ends 256 of the first-type signal conductors 238 may abut the projections 286 of the bottom member 222. The projections 286 of the bottom member 222 may be configured to provide support for and improve impedance imbalance at the cable attachments. The mounting ends 256 of the second-type signal conductors 240 may abut the lower pillars 294 of the lossy member 228. Portions of the intermediate portions 260 of the second-type signal conductors 240 may abut the projections 298 of the upper pillars 292 of the lossy member 228. Such a configuration may provide support for the cable attachments and sufficiently couple the second-type signal conductors 240, which may improve signal integrity at higher speeds.

Referring back to FIG. 2F, the first-type signal conductors 238 and second-type signal conductors 240 may be arranged in groups 280. A group 280 may include one or more pairs of first-type signal conductors 238, each pair of which may be configured for transmitting a pair of differential signals. The intermediate portion 260 of each pair of the first-type signal conductors 238 may have surfaces 266 slanted toward each other so as to enhance coupling between each other.

A group 280 may include second-type signal conductors 240 disposed on opposite sides of each pair of first-type signal conductors 238. The intermediate portion 260 of each of the second-type signal conductors 240 may include a portion 262 bending toward an adjacent first-type signal conductor 238 such that the corresponding mounting end 256 may be disposed closer to the adjacent first-type signal conductor 238 and therefore provide shielding. Some second-type signal conductors 240 may be shared by two pairs of the first-type signal conductors. The intermediate portion 260 of each of these second-type signal conductors 240 may include two portions 262 bending toward adjacent first-type signal conductors 238, respectively. The intermediate portion 260 of each of the second-type signal conductors 240 may include a projection 264 configured to make contact with the projection 298 of the upper pillar 292 of the lossy member 228.

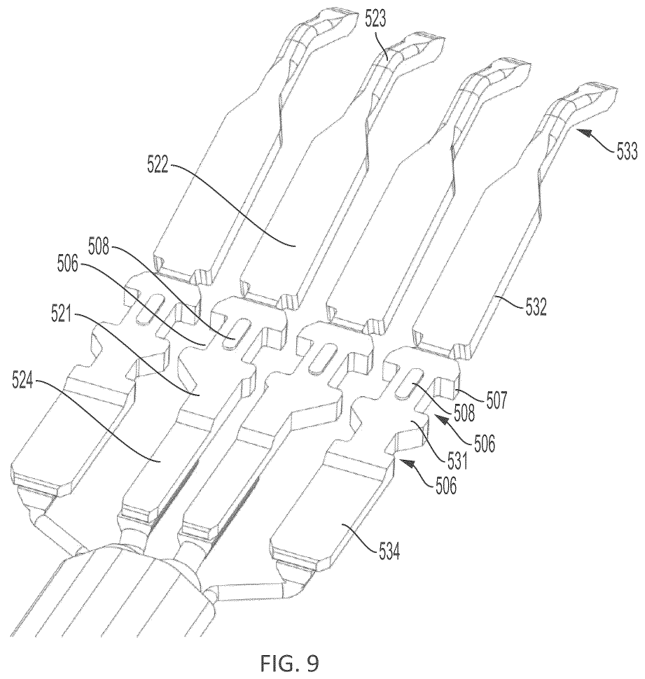

As illustrated, the mating ends 252 of the signal conductors 238, 240 in a group 280 may have a first center-to-center pitch p1 configured for mating with an electronic card (e.g., PCB 104), which may have contact pads uniformly spaced aligned along an edge. The mounting ends of the signal conductors 238, 240 in a group 280 may have a second center-to-center pitch p2 configured for mounting with one cable, which may include a pair of signal wires and a pair of ground wires disposed on opposite sides of the pair of signal wires (see, e.g., FIG. 9). In some embodiments, the mounting ends 256 of the second-type signal conductors 240 may be wider than the mounting ends 256 of the first-type signal conductors 238, which may enhance shielding and therefore improve signal integrity. Accordingly, the second center-to-center pitch p2 between two first-type signal conductors 238 may be different from the second center-to-center pitch p2 between a first-type signal conductor 238 and a second-type signal conductor 240.

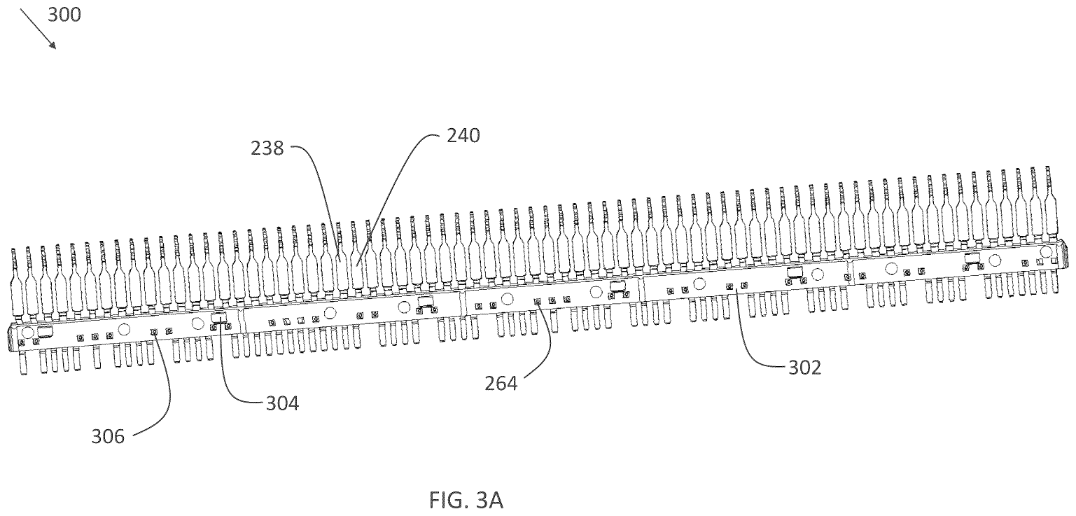

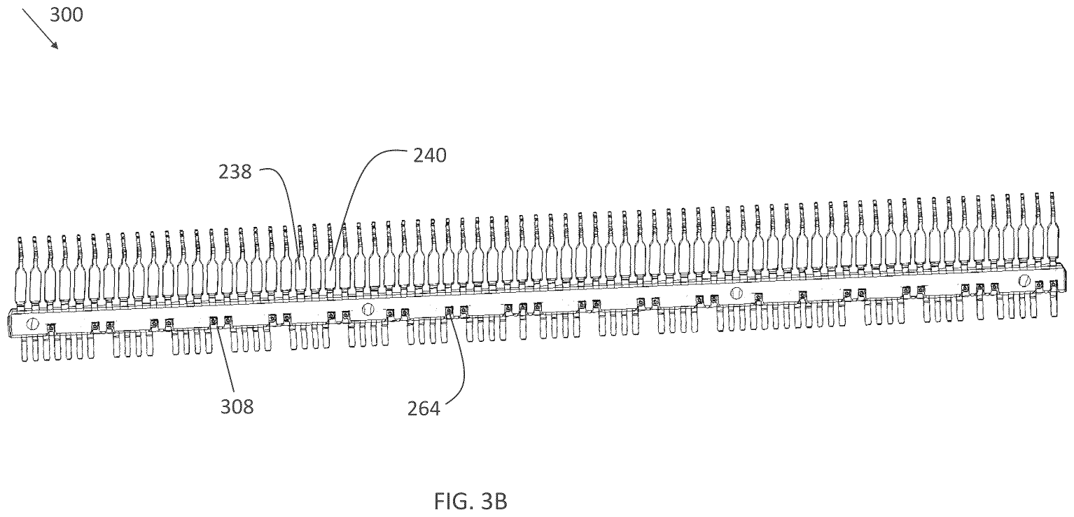

As shown in FIGS. 2D and FIGS. 3A-3B, the signal conductors 238, 240 in a row may be held by a subassembly housing 302, which may enable more precise spacing between the signal conductors 238, 240 and therefore reduce impedance imbalance along the lengths of the signal conductors 238, 240, improving signal integrity at higher speed. The subassembly housing 302 may include projections 304 configured to be disposed in matching openings of the housing 202 (see FIG. 4B). The subassembly housing 302 may include openings 306 and 308 disposed and sized corresponding to the projections 264 of the second-type signal conductors 240 such that the projections 264 may make contact with the projection 298 of the upper pillar 292 of the lossy member 228.

Referring to FIGS. 2C, 4E, the second portion 206 of the housing 202 may include spaces 404 between separators 231 and walls 406. The spaces 404 may be sized and shaped for holding respective subassembly housings 302. Such a configuration may ensure accurate positioning of the subassemblies 300 in the second portion 206 of the housing 202. Such a configuration may also ensure accurate relative positioning of the subassemblies 300 with respect to the bottom member 222 and the lossy member 228, for example, when combined with the matching projections 230 of the housing 202 and openings 232 of the lossy member 228 and openings 234 of the bottom member 222.

In some embodiments, the bottom member 222 and/or the lossy member 228 may be inserted into position after the subassemblies 300 are inserted. The bottom member 222 and/or the lossy member 228 described herein may provide support to the signal conductors 238, 240 so as to keep coplanarity among the signal conductors 238, 240 in each subassembly 300. The bottom member 222 and/or the lossy member 228 described herein may reduce the risks of distortion when cables are welded to the signal conductors 238, 240. The bottom member 222 and/or the lossy member 228 described herein may also block dust, moisture and other, solder flux of gas or other contaminants from entering the inside of the housing 202.

### Second Embodiment

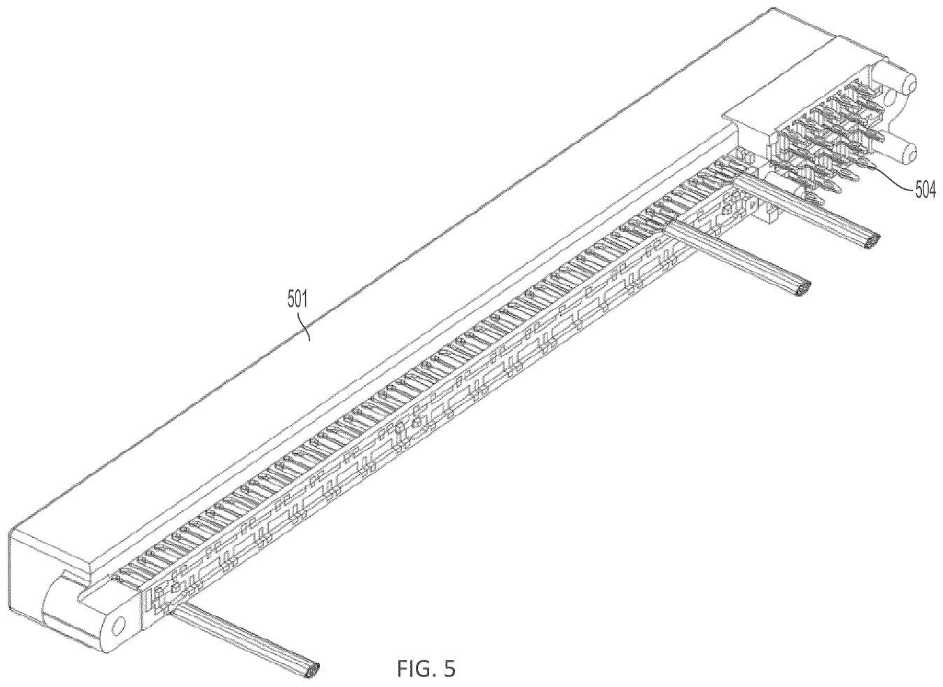

As shown in FIG. 5, the present embodiment provides a connector including a connector housing 501, and first-type signal conductors 502 (which may be configured for transmitting signals), second-type signal conductors 503 (which may be configured for providing reference or return paths to the signals), and power conductors 504 arranged in the connector housing 501. The first-type signal conductors 502 and second-type signal conductors 503 are arranged at intervals. Every two first-type signal conductors 502 are disposed close to each other for increased coupling, and one or two second-type signal conductors 503 are arranged on both sides of every two first-type signal conductors 502. The power conductors 504 are arranged in the connector housing 501 on one side of the first-type signal conductors 502 and second-type signal conductors 503.

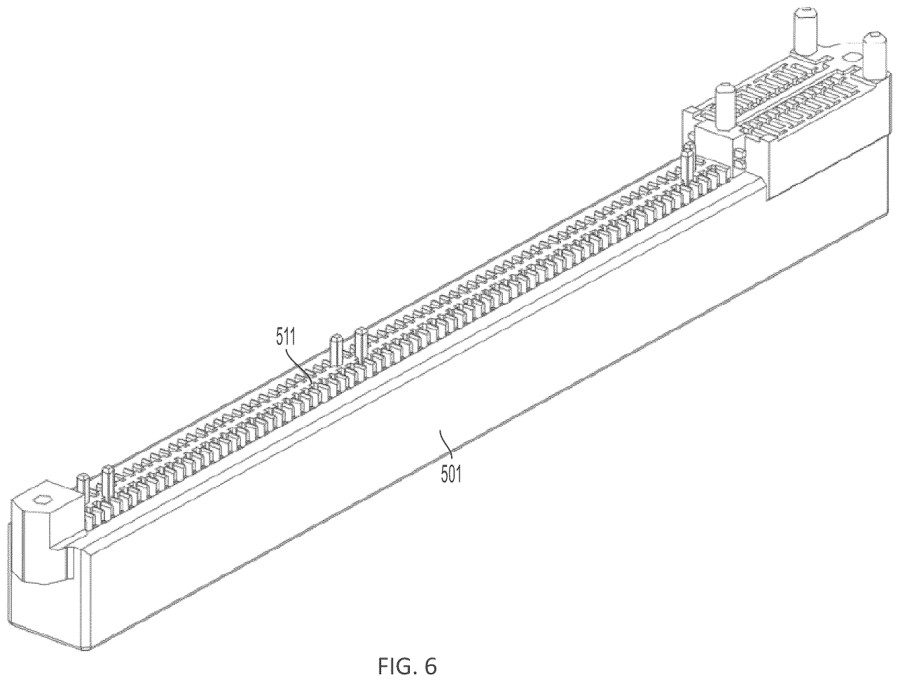

As shown in FIG. 6, the connector housing 501 is an elongated stepped structure, and have slot 511 along the length direction.

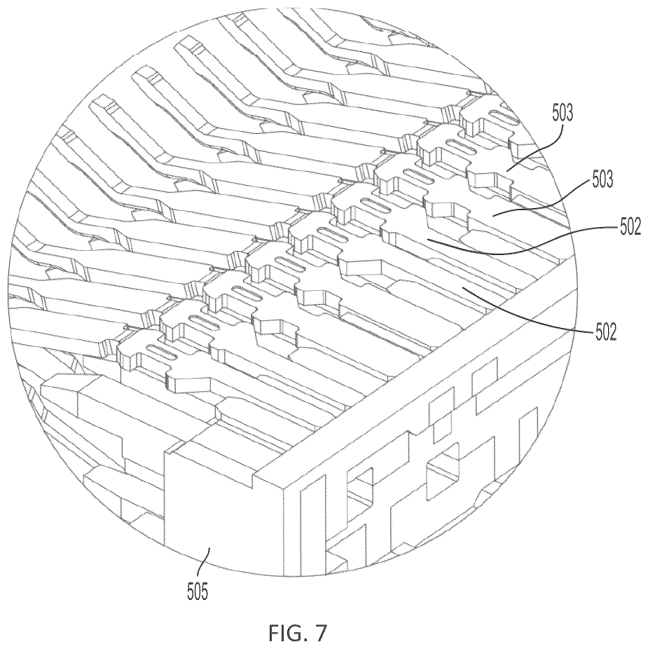

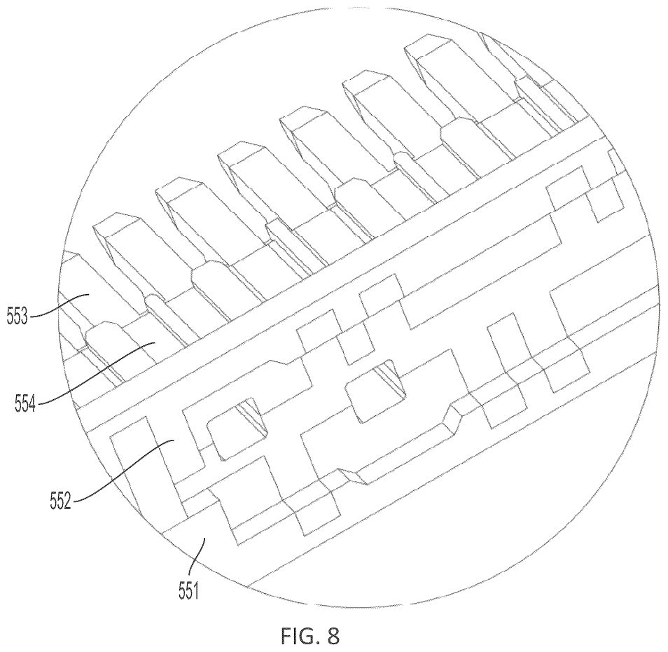

As shown in FIGS. 7, 8, a lossy member 505 may be provided in the connector housing 501. The lossy member 505 comprises a first portion 551 and second portion 552. The second portion 552 is plugged into the first portion 551. The first portion 551 and the second portion 552 are provided with protruding support blocks 553. The first-type signal conductors 502 and second-type signal conductors 503 are supported by the support blocks 553. The first portion 551 is provided with grooves 554. The first-type signal conductors 502 extend to the grooves 554 of the first portion 551.

As shown in FIG. 9, each first-type signal conductor 502 includes a body 521. One side of the body 521 is integrally formed with a connecting arm 522. A contact end 523 is integrally formed on one side of the connecting arm 522. A welding end 524 is integrally formed on the other side of the body 521. In the illustrated example, the width of the contact end 523 is less than the width of the connecting arm 522, which increases the impedance of the contact position. There is an inclined step between the body 521 and the welding end 524.

Both sides of the body 521 are also provided with grooves 506. The grooves 506 have corresponding barb projections 507 on both sides. In the illustrated example, the barb projection 507 on one side of the body 521 is larger than the barb projection 507 on the other side of the body 521.

The body 521 is also provided with a projection 508 for contact with the connector housing 501.

The two second-type signal conductors 503 includes a body 531. One side of the body 531 is integrally formed with a connecting arm 532. A contact end 533 is integrally formed on one side of the connecting arm 532. A welding end 534 is integrally formed on the other side of the body 531. In the illustrated example, the width of the contact end 533 is less than the width of the connecting arm 532, which increases the impedance of the contact position. There is an inclined step between the body 531 and the welding end 534.

Grooves 506 are also provided on both sides of the body 531. The two sides of the grooves 506 have corresponding barbed protrusions 507.

The body 531 is also provided with a projection 508 for contact with the lossy member 505.

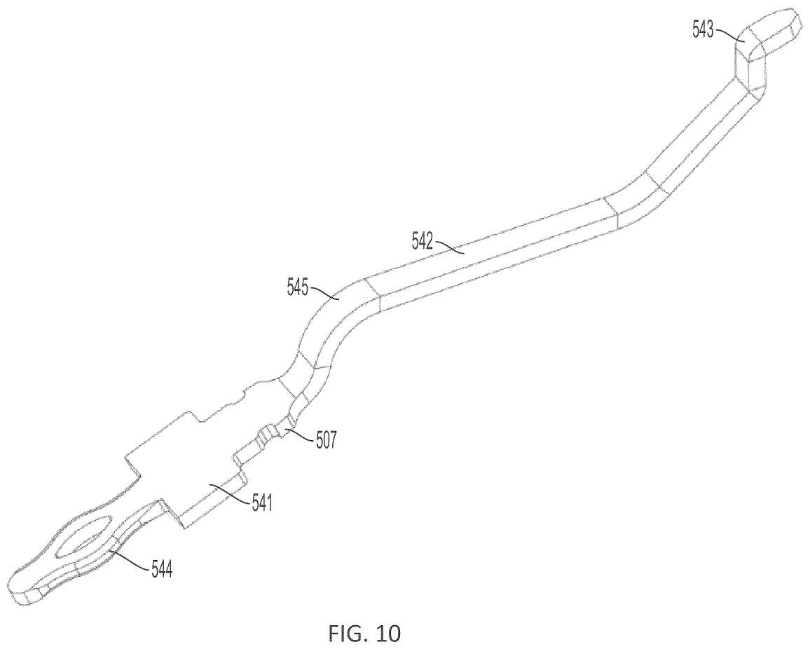

As shown in FIG. 10, each power conductor 504 comprises a body 541. One side of the body 541 is integrally formed with connecting arm 542. The connecting arm 542 is integrally formed with a contact end 543. The other side of the body 541 is integrally formed with a welding end 544. In the illustrated example, the connecting arm 542 has bending parts 545. Both sides of the body 541 are also provided with barb protrusions 507.

### Third Embodiment

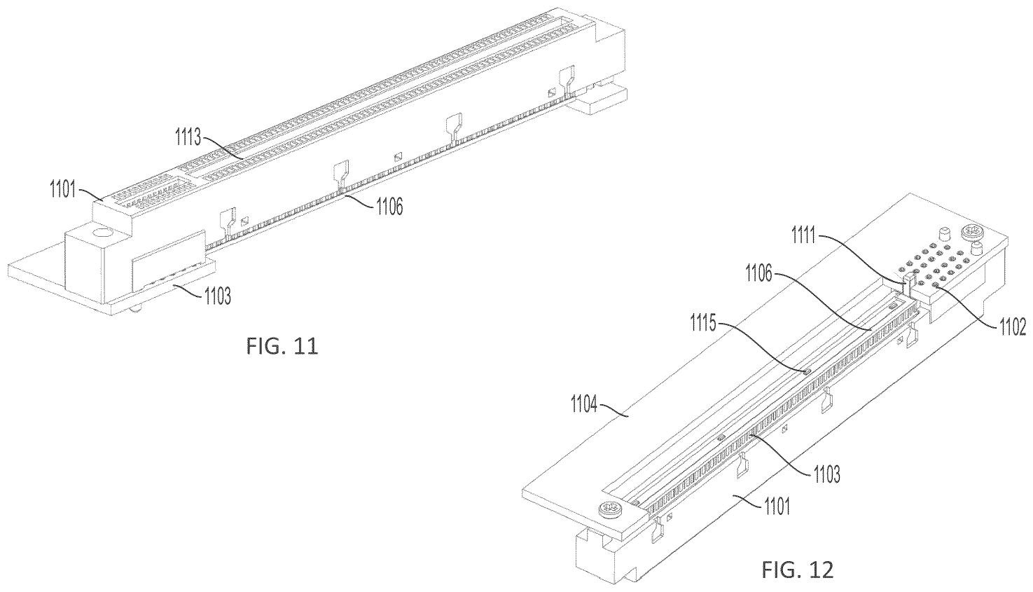

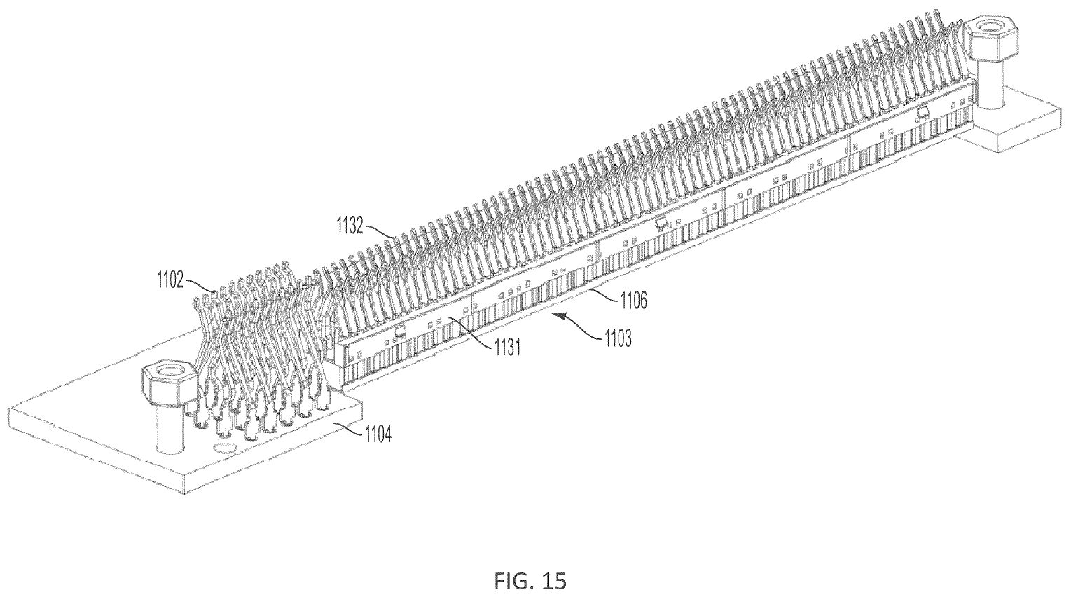

As shown in FIGS. 11, 12, 15, this embodiment provides a PCIe cable connector, including a housing 1101, and power conductors 1102 (or power terminals) and signal conductor subassemblies 1103 disposed in the housing 1101. Lower ends of the power conductor 1102 are mounted to PCB 1104.

Each signal conductor subassembly 1103 includes a body 1131, and signal conductors 1132 insert molded in the body 1131. The signal conductors 1132 may include first-type signal conductors configured for transmitting high-speed signals or low-speed signals and second-type signal conductors configured for providing reference or return path for the signals. The signal conductors 1132 have cables welded thereon by laser. The signal conductor subassembly 1103 (or the signal terminal assembly) welded with cables is inserted into the housing 1101.

The housing 1101 has a lossy member 1105 and a bottom member 1106 disposed therein. The lossy member 1105 is removably disposed in the bottom member 1106. The lossy member 1105 contacts with the second-type signal conductors of the signal conductor subassembly 1103.

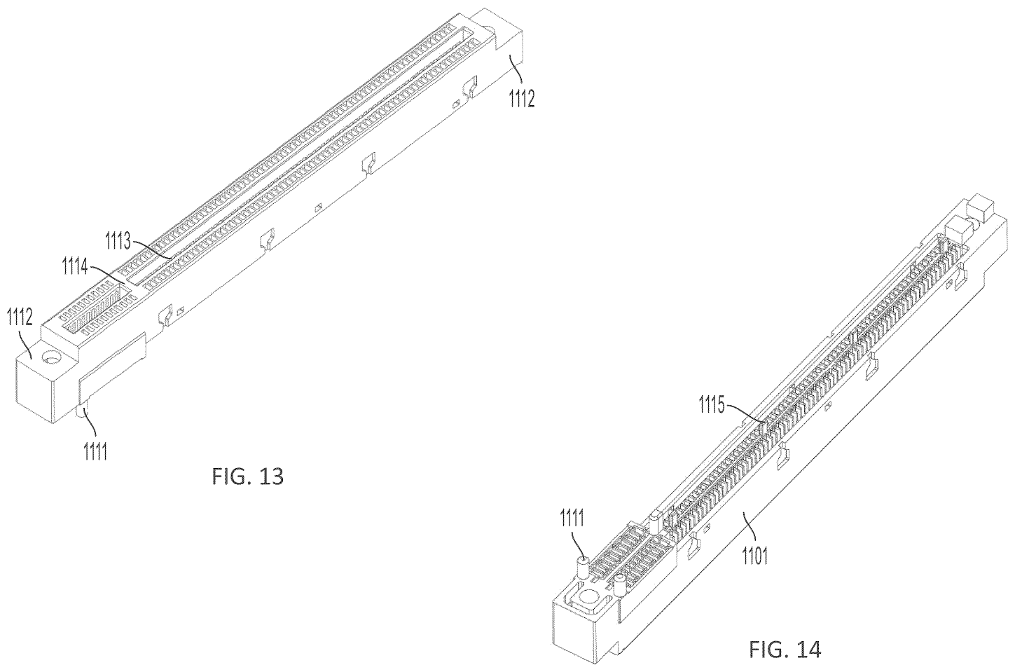

As shown in the FIGS. 13, 14, the lower end of the housing 1101 is provided with multiple connecting posts 1111. The connection posts 1111 are inserted into the PCB 1104. The housing 1101 has connecting seats 1112 at both ends. The connecting seats 1112 are connected to PCB 1104 through bolts.

The upper end of the housing 1101 is provided with a bar-shaped slot 1113. A partition 1114 is disposed in the slot 1113 so as to divide the slot 1113 into two portions corresponding to power conductors 1102 and signal conductors 1132, respectively.

The lower end of the housing 1101 is also provided with multiple connecting rods 1115 configured for connecting with the bottom member 1106.

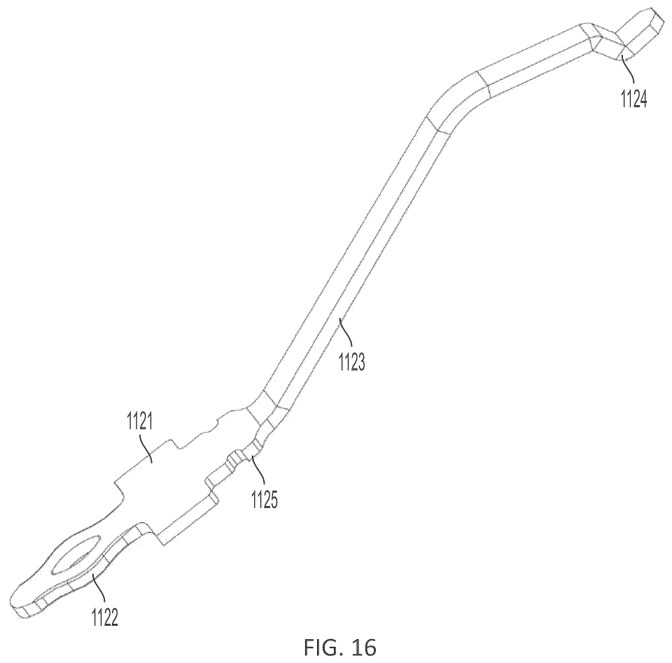

As shown in FIG. 16, each power conductor 1102 includes a body 1121. One end of the power conductor 1102 is provided with a fish-eye type soldering end 1122. The other end of the power conductor 1102 is provided with a connecting arm 1123. The end with connecting arm 1123 has contact end 1124, which is Z-shaped.

Two sides of the body 1121 of the power conductor 1102 have bump 1125 configured for snapping on the housing 1101.

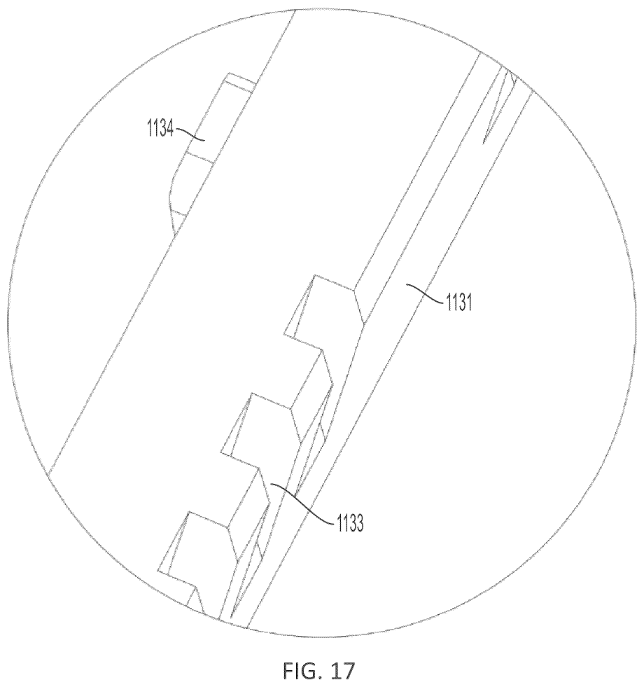

As shown in FIG. 17, the body 1131 of a signal conductor subassembly 1103 has grooves 1133 disposed corresponding to the second-type signal conductors. The lossy member 1105 is inserted into the groove 1133 so as to make contact with the second-type signal conductors of the signal conductors 1132.

The body 1131 of the signal conductor subassembly 1103 has a number of limit bumps 1134 configured for preventing the body 1131 from moving.

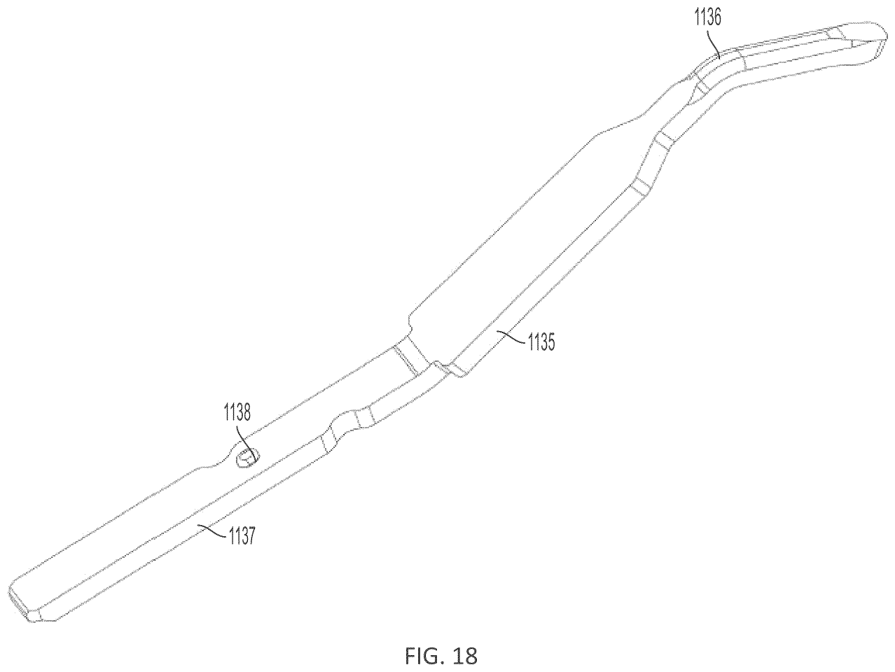

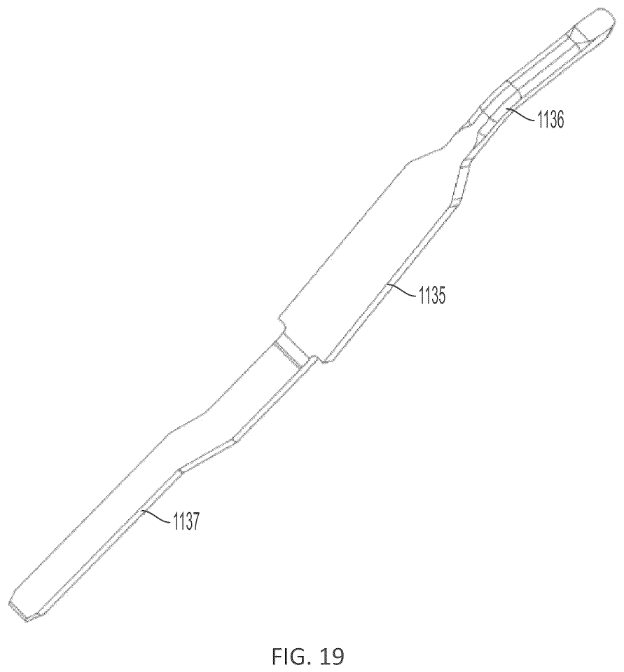

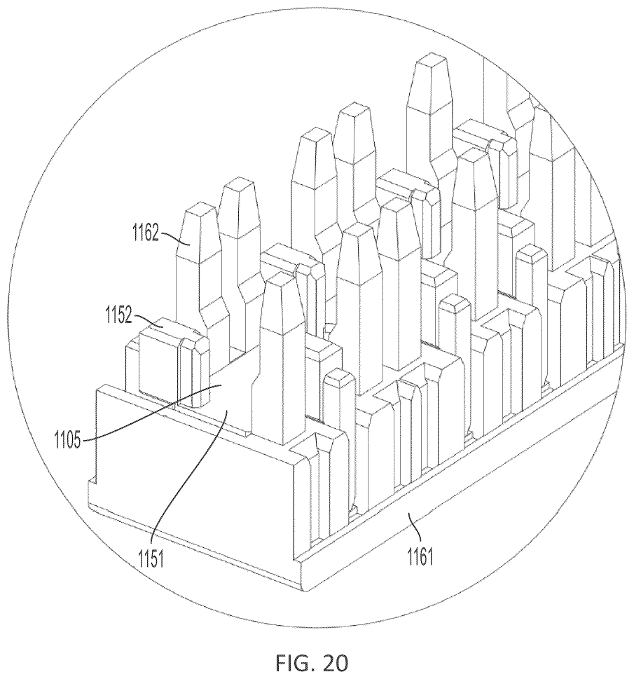

As shown in the FIGS. 18, 19, each signal conductor 1132 includes a body 1135. One end of the body 1135 is provided with a contact end 1136. The other end of the body 1135 has a connecting arm 1137. A portion of the connecting arm 1137 that extends out of the body 1131 serves as a welding part for cables to be welded thereon.

The connecting arm 1137 of the second-type signal conductor has projections 1138 configured for contacting the lossy member 1105.

As shown in FIG. 20, the lossy member 1105 is disposed in the housing 1101 between two signal conductor subassemblies 1103. The lossy member 1105 includes a body 1151, and connecting arms 1152 symmetrically disposed on two sides of the body 1151.

The bottom member 1106 includes a body 1161. The body 1161 includes multiple support pillars 1162 symmetrically disposed on the body 1161. The body 1131 of a signal conductor subassembly 1103 is disposed on the outside of the support pillars 1162.

### Fourth Embodiment

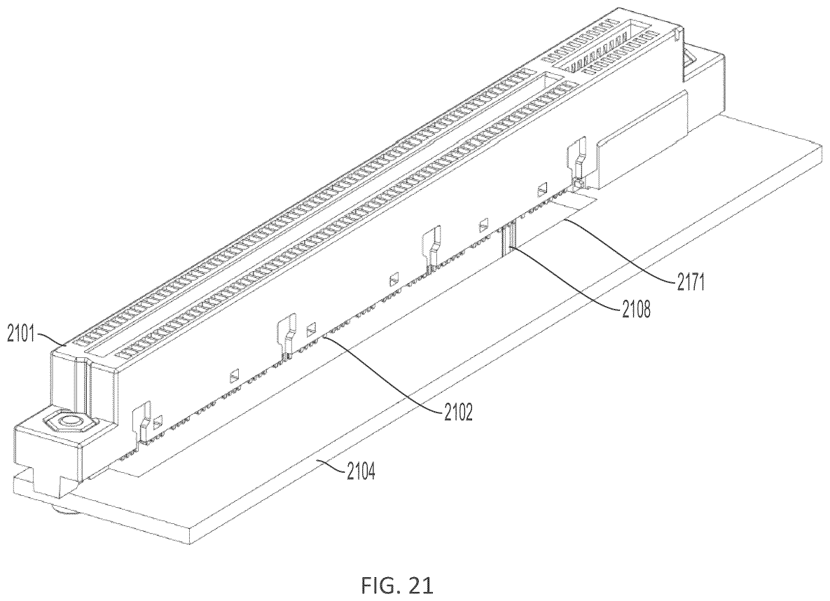

As shown in FIGS. 21-23, this embodiment provides a connector for transmitting power from board and signals from cables. The connector includes a housing 2101, which holds two rows of first conductors 2103 and second conductors 2102. The housing 2101 is removably disposed on PCB 2104. In the illustrated example, like PCB 102 of the electronic system 100, PCB 2104 may include a recess 2171 or an opening (not shown) for cables mounted onto the second conductors 2102 of the connector to pass through such that the cables may be routed to designed locations on PCB 2104 and/or another component.

The PCB 2104 may have a power adapter 2105 disposed thereon. The first conductors 2103 may make contact with the power adapter 2105. Such configuration enables the first conductors 2103 to be electrically coupled to PCB 2104 through the power adapter 2105, which removes the need to solder the first conductors 2103 on the PCB 2104 and therefore facilitates the following maintenance and reduces maintenance costs.

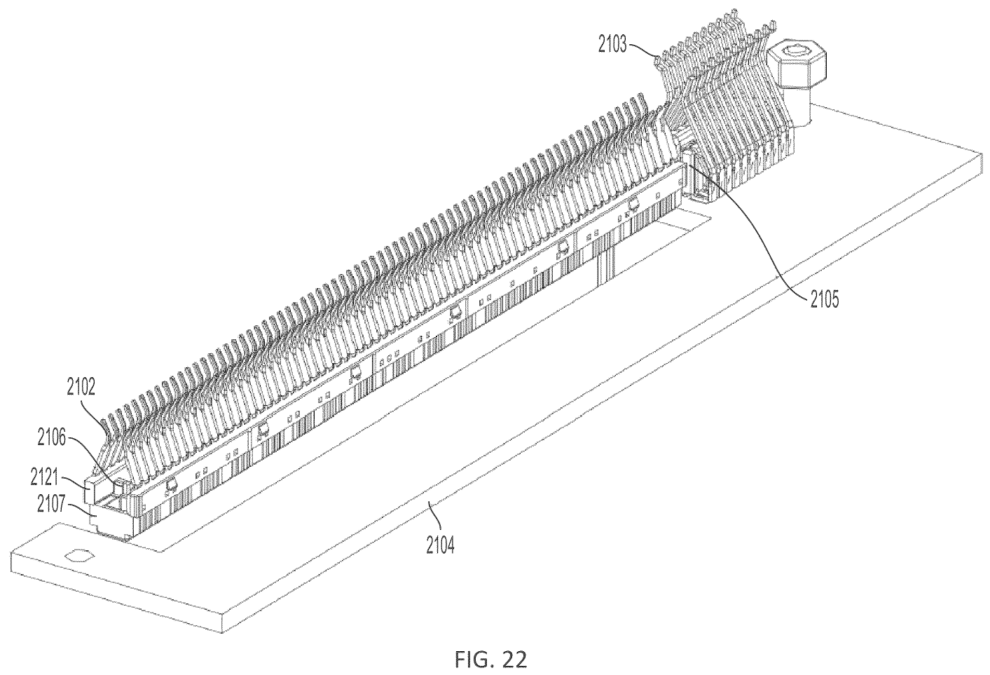

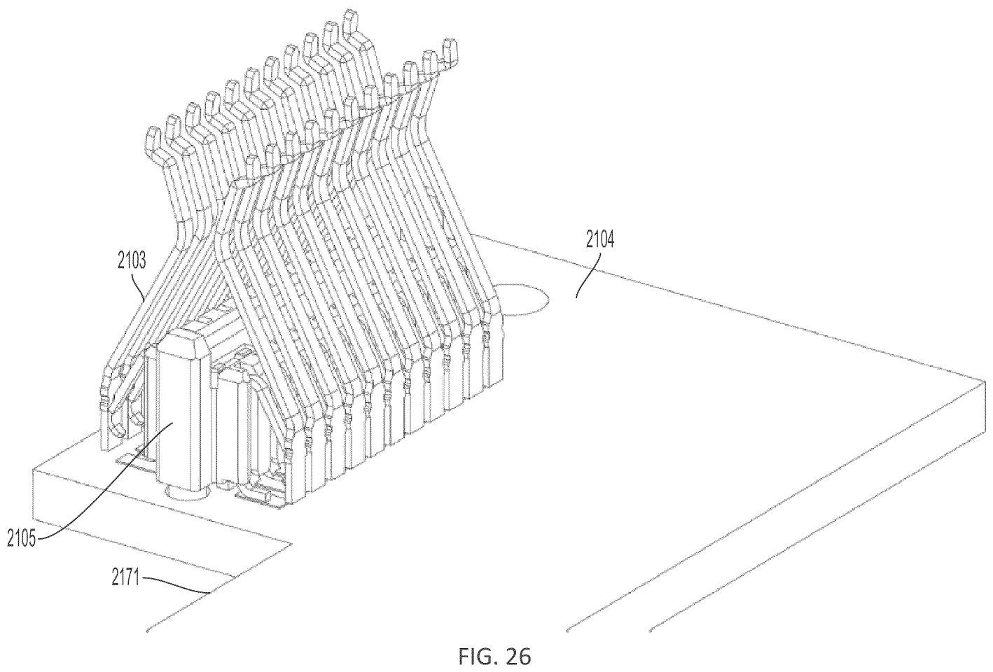

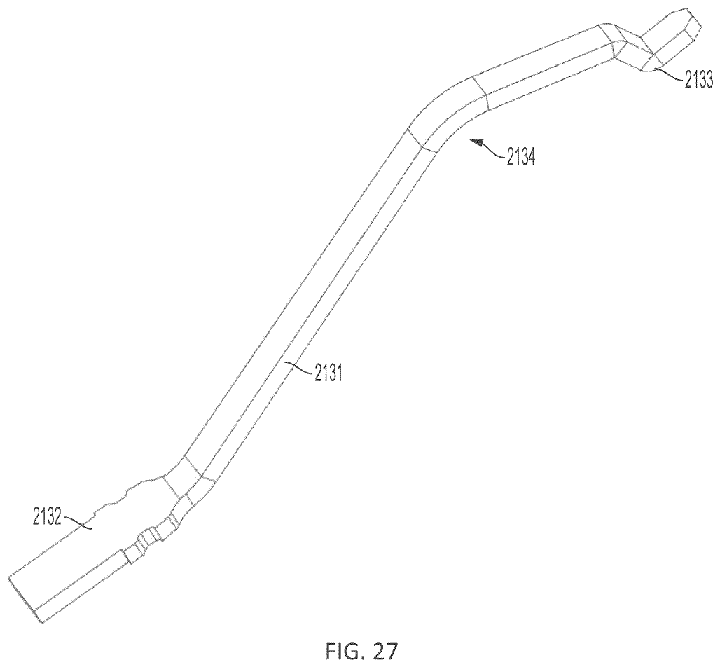

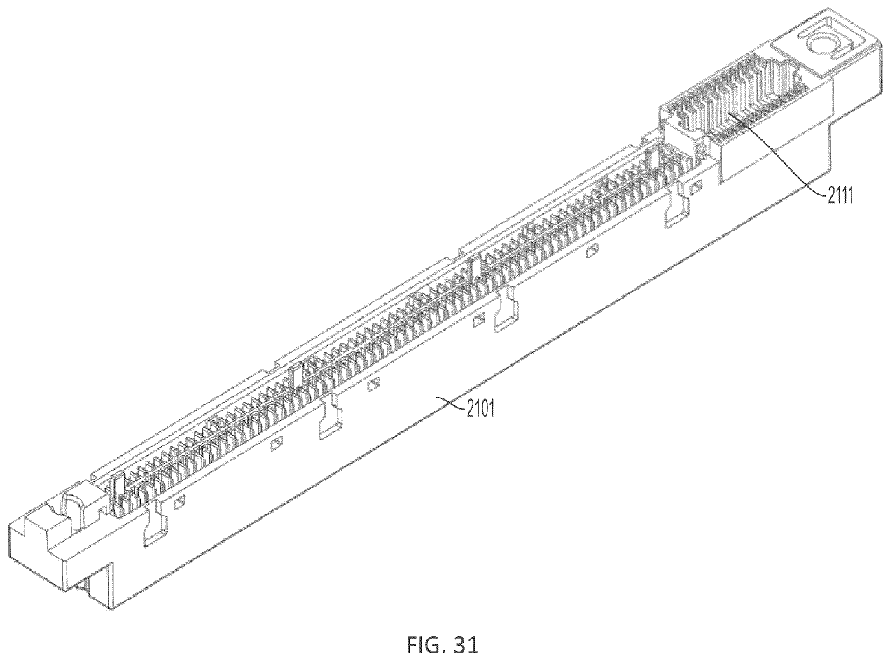

As shown in FIGS. 22, 26, the power adapter 2105 are soldered on PCB 2104. As shown in FIG. 31, the housing 2101 has a cavity 2111 configured for accommodating the power adaptor 2105.

In the illustrated example, the PCB 2104 also has a recess, which facilitates the second conductors 2102 to be connected with external cables 2108.

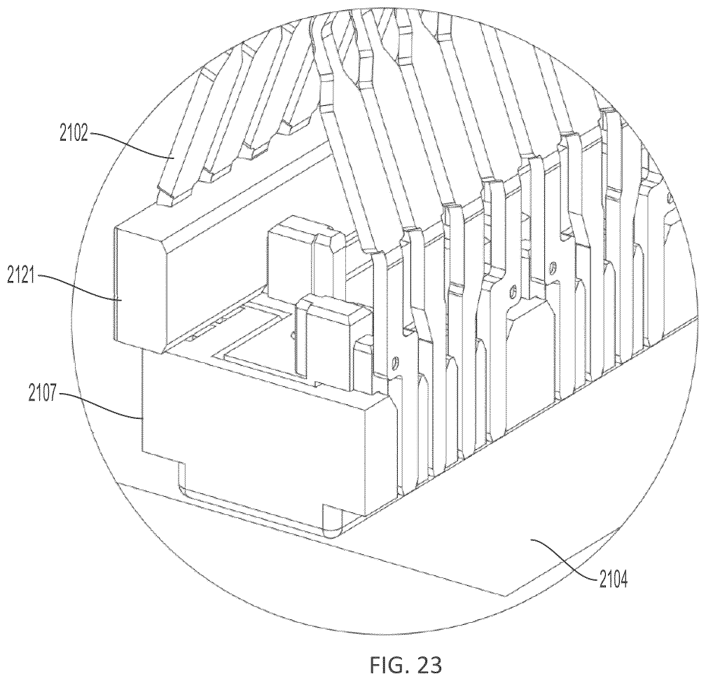

Referring back FIGS. 22, 23, in the illustrated example, the second conductors 2102 evenly inserted in a subassembly housing 2121. The distance between two adjacent second conductors is 0.75 mm. Lower ends of a portion of the second conductors 2102 make contact with a lossy member 2106. The lossy member 2106 is disposed in a bottom member 2107.

The cables 2108 are welded to the second conductors 2102 by laser. To avoid the impact on the subassembly housing 2121 by high heat during the welding process, the cables 2108 may be first welded onto the second conductors 2102, then the second conductors 2102 with the cables 2108 welded thereon may be inserted in the subassembly housing 2121, and lastly the subassembly may be inserted into the housing 2101 from the bottom.

The subassembly housing 2121 includes grooves corresponding to the lossy member 2106. Contact portions 2161 of the lossy member 2106 extend into the grooves and make contact with selected ones of the second conductors 2102.

The subassembly housing 2121 is also provided with multiple stop blocks for matching with the housing 2101.

The second conductors 2102 include first-type second conductors 2122 and second-type second conductors 2123. The second-type second conductors 2123 are configured as ground conductors for contacting the lossy member 2106.

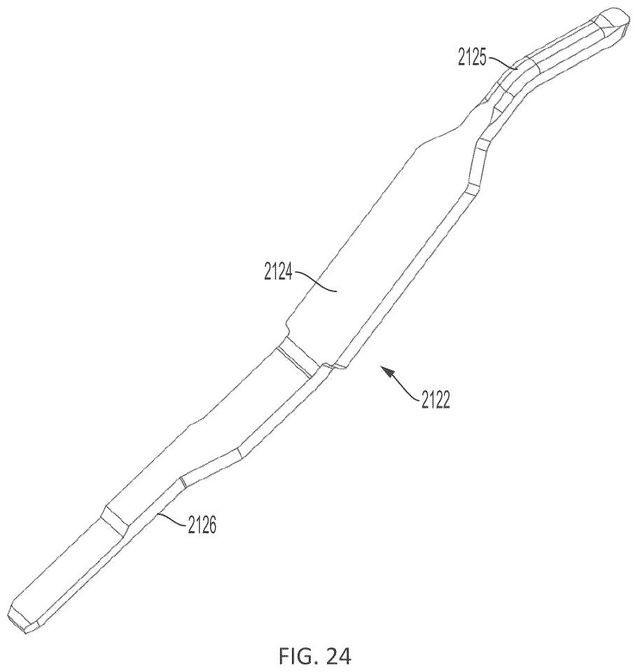

As shown in FIG. 24, each first-type second conductor 2122 includes a body 2124, and a contact end 2125 and solder end 2126 on opposite ends of the body 2124.

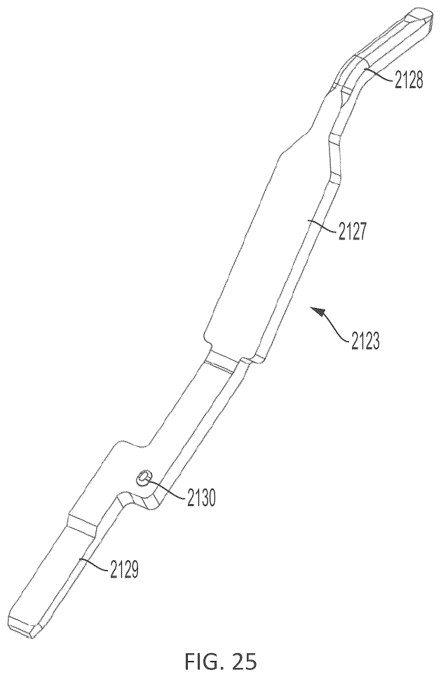

As shown in FIG. 25, each second-type second conductor 2123 includes a body 2127, and a contact end 2128 and solder end 2129 on opposite ends of the body 2127. The solder end 2129 is Z-shaped, and has a projection 2130 configured for making contact with the lossy member 2106. The projection 2130 is disposed in the groove of the subassembly housing 2121.

As shown in FIGS. 26, 27, each first conductor 2103 includes a body 2131, and a contact end 2132 and contact end 2133 on opposite ends of the body 2131. The contact end 2132 has a flat structure and makes contact with the power adapter 2105. The body 2131 has multiple V-shaped bending portions 2134.

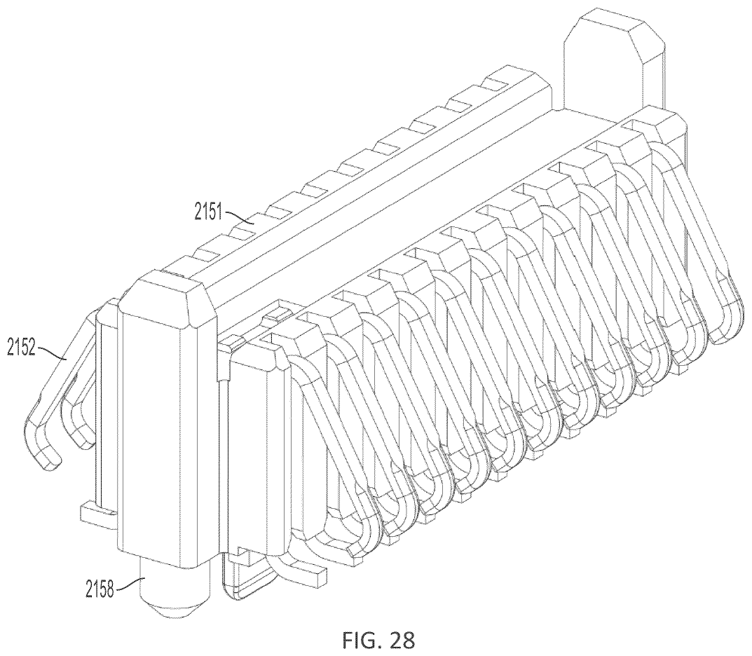

As shown in FIGS. 26, 28, the power adapter 2105 includes an adapter housing 2151, and the multiple third conductors 2152 held by the adapter housing 2151.

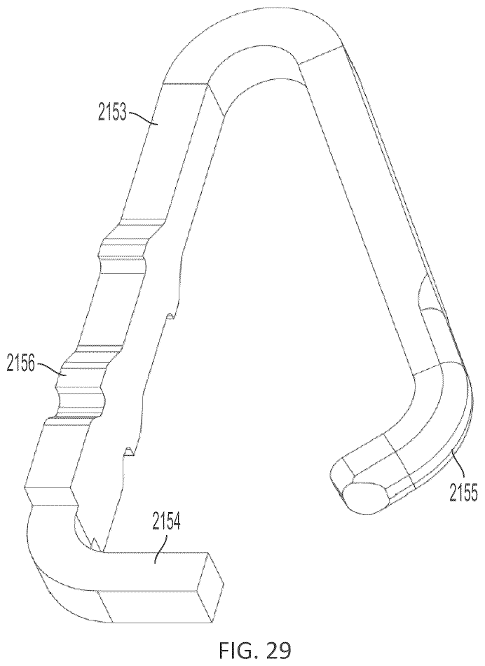

As shown in FIG. 29, each third conductor 2152 has a triangular-like ring structure. Each third conductor 2152 includes a body 2153, and a soldering end 2154 and contact end 2155 on opposite ends of the body 2153. The soldering ends 2154 are soldered to the PCB 2104. The contact ends 2155 make contact with the first conductors 2103. The third conductors 2152 have holding portions 2156 configured for matching the adaptor housing 2151.

As shown in FIG. 28, the adapter housing 2151 have posts 2158 on both ends and configured for connecting with the PCB 2104.

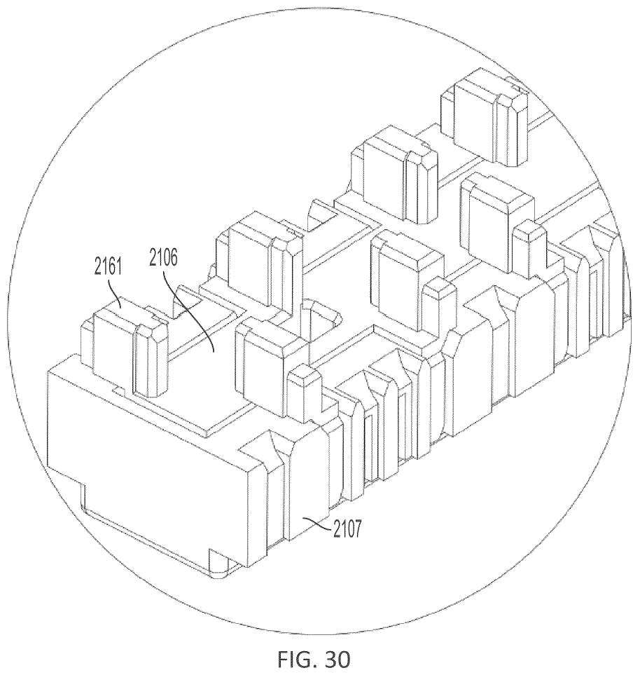

As shown in FIG. 30, the lossy member 2106 is disposed in the bottom member 2107, and has a plurality of contact portions 2161.

### Further Considerations

In some embodiments, housing components, such as the housing 202 and bottom member 222, may be dielectric members molded from a dielectric material such as plastic or nylon. Examples of suitable materials include, but are not limited to, liquid crystal polymer (LCP), polyphenyline sulfide (PPS), high temperature nylon or polyphenylenoxide (PPO) or polypropylene (PP). Other suitable materials may be employed, as aspects of the present disclosure are not limited in this regard.

In some embodiments, conductive elements such as power conductors 236 and signal conductors 238, 240 may be made of metal or any other material that is conductive and provides suitable mechanical properties for conductive elements in an electrical connector. Phosphor-bronze, beryllium copper and other copper alloys are non-limiting examples of materials that may be used. The conductive elements may be formed from such materials in any suitable way, including by stamping and/or forming.

In some embodiments, lossy members such as lossy member 228 may be made of materials that dissipate a sufficient portion of the electromagnetic energy interacting with that material to appreciably impact the performance of a connector may be regarded as lossy. A meaningful impact results from attenuation over a frequency range of interest for a connector. In some configurations, lossy material may suppress resonances within ground structures of the connector and the frequency range of interest may include the natural frequency of the resonant structure, without the lossy material in place. In other configurations, the frequency range of interest may be all or part of the operating frequency range of the connector.

For testing whether a material is lossy, the material may be tested over a frequency range that may be smaller than or different from the frequency range of interest of the connector in which the material is used. For example, the test frequency range may extend from 10 GHz to 25 GHz or 1 GHz to 5 GHz. Alternatively, lossy material may be identified from measurements made at a single frequency, such as 10 GHz or 15 GHZ.

Loss may result from interaction of an electric field component of electromagnetic energy with the material, in which case the material may be termed electrically lossy. Alternatively or additionally, loss may result from interaction of a magnetic field component of the electromagnetic energy with the material, in which case the material may be termed magnetically lossy.

Electrically lossy materials can be formed from lossy dielectric and/or poorly conductive materials. Electrically lossy material can be formed from material traditionally regarded as dielectric materials, such as those that have an electric loss tangent greater than approximately 0.01, greater than 0.05, or between 0.01 and 0.2 in the frequency range of interest. The “electric loss tangent” is the ratio of the imaginary part to the real part of the complex electrical permittivity of the material.

Electrically lossy materials can also be formed from materials that are generally thought of as conductors, but are relatively poor conductors over the frequency range of interest. These materials may conduct, but with some loss, over the frequency range of interest such that the material conducts more poorly than a conductor of an electrical connector, but better than an insulator used in the connector. Such materials may contain conductive particles or regions that are sufficiently dispersed that they do not provide high conductivity or otherwise are prepared with properties that lead to a relatively weak bulk conductivity compared to a good conductor such as pure copper over the frequency range of interest. Die cast metals or poorly conductive metal alloys, for example, may provide sufficient loss in some configurations.

Electrically lossy materials of this type typically have a bulk conductivity of about 1 Siemen/meter to about 100,000 Siemens/meter, or about 1 Siemen/meter to about 30,000 Siemens/meter, or 1 Siemen/meter to about 10,000 Siemens/meter. In some embodiments, material with a bulk conductivity of between about 1 Siemens/meter and about 500 Siemens/meter may be used. As a specific example, material with a conductivity between about 50 Siemens/meter and 300 Siemens/meter may be used. However, it should be appreciated that the conductivity of the material may be selected empirically or through electrical simulation using known simulation tools to determine a conductivity that provides suitable signal integrity (SI) characteristics in a connector. The measured or simulated SI characteristics may be, for example, low cross talk in combination with a low signal path attenuation or insertion loss, or a low insertion loss deviation as a function of frequency.

It should also be appreciated that a lossy member need not have uniform properties over its entire volume. A lossy member, for example, may have an insulative skin or a conductive core, for example. A member may be identified as lossy if its properties on average in the regions that interact with electromagnetic energy sufficiently attenuate the electromagnetic energy.

In some embodiments, lossy material is formed by adding to a binder a filler that contains particles. In such an embodiment, a lossy member may be formed by molding or otherwise shaping the binder with filler into a desired form. The lossy material may be molded over and/or through openings in conductors, which may be ground conductors or shields of the connector. Molding lossy material over or through openings in a conductor may ensure intimate contact between the lossy material and the conductor, which may reduce the possibility that the conductor will support a resonance at a frequency of interest. This intimate contact may, but need not, result in an Ohmic contact between the lossy material and the conductor.

Alternatively or additionally, the lossy material may be molded over or injected into insulative material, or vice versa, such as in a two shot molding operation. The lossy material may press against or be positioned sufficiently near a ground conductor that there is appreciable coupling to a ground conductor. Intimate contact is not a requirement for electrical coupling between lossy material and a conductor, as sufficient electrical coupling, such as capacitive coupling, between a lossy member and a conductor may yield the desired result. For example, in some scenarios, 100 pF of coupling between a lossy member and a ground conductor may provide an appreciable impact on the suppression of resonance in the ground conductor. In other examples with frequencies in the range of approximately 10 GHz or higher, a reduction in the amount of electromagnetic energy in a conductor may be provided by sufficient capacitive coupling between a lossy material and the conductor with a mutual capacitance of at least about 0.005 pF, such as in a range between about 0.01 pF to about 100 pF, between about 0.01 pF to about 10 pF, or between about 0.01 pF to about 1 pF. To determine whether lossy material is coupled to a conductor, coupling may be measured at a test frequency, such as 15 GHz or over a test range, such as 10 GHz to 25 GHZ.

To form an electrically lossy material, the filler may be conductive particles. Examples of conductive particles that may be used as a filler to form an electrically lossy material include carbon or graphite formed as fibers, flakes, nanoparticles, or other types of particles. Various forms of fiber, in woven or non-woven form, coated or non-coated may be used. Non-woven carbon fiber is one suitable material. Metal in the form of powder, flakes, fibers or other particles may also be used to provide suitable electrically lossy properties. Alternatively, combinations of fillers may be used. For example, metal plated carbon particles may be used. Silver and nickel are suitable metal plating for fibers. Coated particles may be used alone or in combination with other fillers, such as carbon flake.

Preferably, the fillers will be present in a sufficient volume percentage to allow conducting paths to be created from particle to particle. For example, when metal fiber is used, the fiber may be present in about 3% to 30% by volume. The amount of filler may impact the conducting properties of the material, and the volume percentage of filler may be lower in this range to provide sufficient loss.

The binder or matrix may be any material that will set, cure, or can otherwise be used to position the filler material. In some embodiments, the binder may be a thermoplastic material traditionally used in the manufacture of electrical connectors to facilitate the molding of the electrically lossy material into the desired shapes and locations as part of the manufacture of the electrical connector. Examples of such materials include liquid crystal polymer (LCP) and nylon. However, many alternative forms of binder materials may be used. Curable materials, such as epoxies, may serve as a binder. Alternatively, materials such as thermosetting resins or adhesives may be used.

While the above-described binder materials may be used to create an electrically lossy material by forming a binder around conducting particle fillers, lossy materials may be formed with other binders or in other ways. In some examples, conducting particles may be impregnated into a formed matrix material or may be coated onto a formed matrix material, such as by applying a conductive coating to a plastic component or a metal component. As used herein, the term “binder” encompasses a material that encapsulates the filler, is impregnated with the filler or otherwise serves as a substrate to hold the filler.

Magnetically lossy material can be formed, for example, from materials traditionally regarded as ferromagnetic materials, such as those that have a magnetic loss tangent greater than approximately 0.05 in the frequency range of interest. The “magnetic loss tangent” is the ratio of the imaginary part to the real part of the complex electrical permeability of the material. Materials with higher loss tangents may also be used.

In some embodiments, a magnetically lossy material may be formed of a binder or matrix material filled with particles that provide that layer with magnetically lossy characteristics. The magnetically lossy particles may be in any convenient form, such as flakes or fibers. Ferrites are common magnetically lossy materials. Materials such as magnesium ferrite, nickel ferrite, lithium ferrite, yttrium garnet or aluminum garnet may be used. Ferrites will generally have a loss tangent above 0.1 at the frequency range of interest. Presently preferred ferrite materials have a loss tangent between approximately 0.1 and 1.0 over the frequency range of 1 GHz to 3 GHZ and more preferably a magnetic loss tangent above 0.5 over that frequency range.

Practical magnetically lossy materials or mixtures containing magnetically lossy materials may also exhibit useful amounts of dielectric loss or conductive loss effects over portions of the frequency range of interest. Suitable materials may be formed by adding fillers that produce magnetic loss to a binder, similar to the way that electrically lossy materials may be formed, as described above.

It is possible that a material may simultaneously be a lossy dielectric or a lossy conductor and a magnetically lossy material. Such materials may be formed, for example, by using magnetically lossy fillers that are partially conductive or by using a combination of magnetically lossy and electrically lossy fillers.

Lossy portions also may be formed in a number of ways. In some examples the binder material, with fillers, may be molded into a desired shape and then set in that shape. In other examples the binder material may be formed into a sheet or other shape, from which a lossy member of a desired shape may be cut. In some embodiments, a lossy portion may be formed by interleaving layers of lossy and conductive material such as metal foil. These layers may be rigidly attached to one another, such as through the use of epoxy or other adhesive, or may be held together in any other suitable way. The layers may be of the desired shape before being secured to one another or may be stamped or otherwise shaped after they are held together. As a further alternative, lossy portions may be formed by plating plastic or other insulative material with a lossy coating, such as a diffuse metal coating.

Although details of specific configurations of conductive elements and housings are described above, it should be appreciated that such details are provided solely for purposes of illustration, as the concepts disclosed herein are capable of other manners of implementation. In that respect, various connector designs described herein may be used in any suitable combination, as aspects of the present disclosure are not limited to the particular combinations shown in the drawings.

Having thus described several embodiments, it is to be appreciated various alterations, modifications, and improvements may readily occur to those skilled in the art.

For example, techniques as described herein may be embodied in card edge connectors or connectors configured only for high-speed signals.

As another example, high-speed and low-speed signal conductors may be configured the same, with signal conductors in the same row having the same shape. The high-speed and low-speed signal conductors nonetheless may be differentiated based on the ground structures and insulative portions around them. Alternatively, some or all of the high-speed signal conductors may be configured differently from low-speed signal conductors, even within the same row. The edge-to-edge spacing may be closer for high-speed signal conductors, for example.

Connectors are illustrated that have mating locations and mounting locations that may be compatible with a PCIe standard. Techniques as described herein may be used to increase the operating speed of connectors designed according to other standards.

As another example, exemplary connectors were illustrated in which an entire row of signal conductors was formed as a subassembly. Other examples may have multiple subassemblies per row.

Such alterations, modifications, and improvements are intended to be within the spirit and scope of the invention. Accordingly, the foregoing description and drawings are by way of example only.

Furthermore, techniques for increasing the operating speed of a connector, even when constrained by dimensions specified in an industry standard, are shown and described with reference to a card edge connector, it should be appreciated that aspects of the present disclosure are not limited in this regard, as any of the inventive concepts, whether alone or in combination with one or more other inventive concepts, may be used in other types of electrical connectors, such as receptacle connectors, backplane connectors, right angle connectors, stacking connectors, mezzanine connectors, I/O connectors, chip sockets, etc.

In some embodiments, mounting ends were illustrated as press fit “eye of the needle” that are designed to insert into printed circuit boards. However, other configurations may also be used, such as surface mount contacts, spring contacts, solderable pins, etc.

All definitions, as defined and used, should be understood to control over dictionary definitions, definitions in documents incorporated by reference, and/or ordinary meanings of the defined terms.

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. An electrical connector comprising:
a housing comprising a first portion having a first slot, and a second portion separated from the first portion by a rib and having a second slot;
a plurality of first conductors in the first portion of the housing, each of the plurality of first conductors comprising a mating end comprising a mating contact portion curving into the first slot, and a mounting end extending out of the first portion of the housing and configured to mount to a printed circuit board; and
a plurality of second conductors in the second portion of the housing, each of the plurality of second conductors comprising a mating end comprising a mating contact portion curving into the second slot, a mounting end extending out of the second portion of the housing, and an intermediate portion joining the mating end and the mounting end, wherein the mounting end is thinner than the intermediate portion and configured for a cable to be attached to the mounting end.

2. The electrical connector of claim 1, wherein, for each of the plurality of second conductors:
the intermediate portion comprises a first surface and a second surface on opposite sides;
the mounting end comprises a third surface and a fourth surface on opposite sides;
the third surface of the mounting end extends from the first surface of the intermediate portion; and
the fourth surface of the mounting end is offset from the second surface of the intermediate portion.

3. The electrical connector of claim 1, wherein:
the mating contact portions of the plurality of first conductors have a first width in a longitudinal direction perpendicular to a mating direction;
the mating contact portions of the plurality of second conductors have a second width in the longitudinal direction; and
the first width is greater than the second width.

4. The electrical connector of claim 3, wherein:
the intermediate portions of the plurality of first conductors have a third width in the longitudinal direction;
the third width equals to the first width;
the intermediate portions of the plurality of second conductors have a fourth width in the longitudinal direction; and
the fourth width is greater than the second width.

5. The electrical connector of claim 4, wherein:
the first portion of the housing comprises a plurality of first channels each configured to hold one of the plurality of first conductors, and a plurality of first separators at least partially dividing the plurality of first channels;
each of the plurality of first separators comprises one or more slots;
each of the plurality of first conductors comprises a wider portion adjacent the mounting end; and
the wider portions extend into the slots of the plurality of first separators.

6. The electrical connector of claim 4, comprising:
a subassembly housing holding the plurality of second conductors in a row in the longitudinal direction perpendicular to the mating direction, wherein:
the second portion of the housing comprises a plurality of second channels each configured to hold one of the plurality of second conductors, and a plurality of second separators at least partially dividing the plurality of second channels; and
the subassembly housing is disposed between the plurality of second separators and a wall of the housing.

7. The electrical connector of claim 1, wherein:
the plurality of first conductors comprise a plurality of first-type first conductors and a plurality of second-type first conductors;
the intermediate portion of each of the plurality of second-type first conductors comprises a portion bending toward the first slot; and
the plurality first-type first conductors and the plurality of second-type first conductors alternate in a longitudinal direction perpendicular to a mating direction;
the mating ends of the plurality of first conductors are aligned in a first line parallel to the longitudinal direction;
the mounting ends of the plurality of first-type first conductors are aligned in a second line parallel to the first line; and
the mounting ends of the plurality of second-type first conductors are aligned in a third line parallel to the first line and offset from the second line in a transverse direction perpendicular to the mating direction and the longitudinal direction.

8. The electrical connector of claim 1, wherein:
the plurality of second conductors comprise a plurality of first-type second conductors and a plurality of second-type second conductors;
the intermediate portion of each of the plurality of first-type second conductors comprises a surface slanted toward an adjacent first-type second conductor; and
the intermediate portion of each of the plurality of second-type second conductors comprises a portion bending toward an adjacent first-type second conductor.

9. The electrical connector of claim 8, wherein:
the intermediate portion of each of the plurality of second-type second conductors comprises a projection protruding toward the second slot.

10. An electrical connector comprising:
a housing comprising a first portion having a first slot, a second portion separated from the first portion by a rib and having a second slot, and a bottom member attached to the second portion;
a plurality of first conductors held by the first portion of the housing, each of the plurality of first conductors comprising a mating end comprising a mating contact portion curving into the first slot, and a mounting end extending out of the first portion of the housing and beyond the bottom member in a mating direction; and
a plurality of second conductors held by the second portion of the housing, each of the plurality of second conductors comprising a mating end comprising a mating contact portion curving into the second slot, and a mounting end extending out of the second portion of the housing and within the bottom member in the mating direction, wherein:
the plurality of first conductors are configured to mount to a printed circuit board; and
the plurality of second conductors are configured to mount with cables.

11. The electrical connector of claim 10, wherein:
the bottom member comprises a body, a plurality of pillars extending from the body toward the second portion of the housing, and a plurality of projections extending from the pillars and toward the mounting ends of the plurality of second conductors.

12. The electrical connector of claim 11, wherein:
a portion of the plurality of projections comprises a plurality of recesses;
each of the plurality of second conductors comprises a transition region between an intermediate portion and the mounting end;
the plurality of second conductors comprise a plurality of first-type second conductors and a plurality of second-type second conductors; and
the transition regions of the plurality of first-type second conductors are disposed in respective recesses of the plurality of recesses.

13. The electrical connector of claim 12, wherein:
the housing further comprises a lossy member configured to electrically couple the plurality of second-type second conductors.

14. The electrical connector of claim 13, wherein:
the lossy member comprises a body, a plurality of first pillars extending from the body toward the second portion of the housing, and a plurality of second pillars extending from the body away from the second portion of the housing and disposed between adjacent pillars of the bottom member.

15. The electrical connector of claim 13, wherein:
the lossy member comprises a plurality of first openings;
the bottom member comprises a plurality of second openings stacked below respective ones of the plurality of first openings of the lossy member in the mating direction; and
the second portion of the housing comprises a plurality of projections each extending through a first opening of the lossy member and a second opening of the bottom member.

16. The electrical connector of claim 12, further comprising:
a subassembly housing holding the plurality of second conductors in a row in a longitudinal direction perpendicular to the mating direction, the subassembly housing comprising a plurality of projections disposed in matching openings of the second portion of the housing.

17. The electrical connector of claim 16, wherein:
the intermediate portion of each of the plurality of second-type second conductors comprises a projection protruding toward the second slot; and
the subassembly housing comprises a plurality of openings disposed corresponding to the projections of the plurality of second-type second conductors.

18. An electronic system comprising:
a printed circuit board;
an electrical connector comprising:
a housing comprising a first portion and a second portion;
a plurality of first conductors in the first portion of the housing, each of the plurality of first conductors comprising a mounting end extending out of the first portion of the housing and mounted to the printed circuit board; and
a plurality of second conductors in the second portion of the housing, each of the plurality of second conductors comprising a mounting end extending out of the second portion of the housing; and
a plurality of cables, each of the plurality of cables comprising a pair of signal wires and at least one ground wire disposed adjacent to the pair of signal wires, each wire of the pair of signal wires and the at least one ground wire being welded to the mounting end of a respective one of the plurality of second conductors.

19. The electronic system of claim 18, wherein:
the printed circuit board comprises a recess or an opening such that the plurality of cables pass through the recess or opening.

20. The electronic system of claim 19, wherein:
the housing of the electrical connector is secured to the printed circuit board at locations on opposite sides of the recess or opening.
